(19) United States
(12) Patent Application Publication
(10) Pub. No.: US 2026/0275893 A1
(43) Pub. Date: Sep. 17, 2026

(54) SYSTEM AND METHOD FOR CONTROLLED HEAT EXCHANGER SWAPPING

(71) Applicant: INNIO Waukesha Gas Engines Inc., Waukesha, WI (US)

(72) Inventor: Lorne Eugene Nix, Waukesha, WI (US)

(21) Appl. No.: 18/875,695

(22) PCT Filed: Jun. 16, 2022
(86) PCT No.: PCT/US2022/033897

§ 371 Date: Dec. 16, 2024

(51) Int. Cl. F01N 11/00; F01N 3/02; F02M 26/23; F02M 26/29; F02M 26/49

(52) U.S. Cl. CPC F01N 11/00; F01N 3/0205; F02M 26/23; F02M 26/29; F02M 26/49; F01N 2240/02; F01N 2550/00

(57) ABSTRACT

A method includes detecting a threshold reduction in performance of at least one heat exchanger of a discrete plurality of heat exchangers coupled to an exhaust circuit of a reciprocating engine. The discrete plurality of heat exchangers is disposed in a first unique arrangement of coupling to the exhaust circuit, wherein each of the plurality of heat exchangers include the same connectors to couple to the exhaust circuit. The method also includes generating an output indicative of a second unique arrangement of the discrete plurality of heat exchangers of coupling to the exhaust circuit. The second unique arrangement of the discrete plurality of heat exchangers has a greater predicted remaining useful life than the first unique arrangement of the discrete plurality of heat exchangers.

### BACKGROUND

The subject matter disclosed herein relates to reciprocating engines and associated heat exchangers.

A reciprocating engine may include a plurality of pistons disposed in respective cylinders in an engine block. The reciprocating engine may include one or more heat exchangers to facilitate cooling. For example, an exhaust gas recirculation (EGR) system of the reciprocating engine may include a cooling system having a heat exchanger. Unfortunately, the heat exchanger may gradually decrease in performance due to fouling (e.g., buildup of substances on the heat transfer surfaces), leakage (e.g., leakage at gaskets and/or tubes), or other problems. For example, the fouling may be caused by the buildup of substances (e.g., carbon deposits) in an exhaust gas when the heat exchanger is used in an exhaust system, e.g., the EGR system. The heat exchanger is typically designed for a single location and application in the reciprocating engine. As a result, once the performance is inadequate, the heat exchanger is removed from the reciprocating engine. Accordingly, a need exists to increase the useful life of the heat exchanger on the reciprocating engine despite the decreases in performance.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In certain embodiments, a method includes detecting a threshold reduction in performance of at least one heat exchanger of a discrete plurality of heat exchangers coupled to an exhaust circuit of a reciprocating engine. The discrete plurality of heat exchangers is disposed in a first unique arrangement of coupling to the exhaust circuit, wherein each of the plurality of heat exchangers include the same connectors to couple to the exhaust circuit. The method also includes generating an output indicative of a second unique arrangement of the discrete plurality of heat exchangers of coupling to the exhaust circuit. The second unique arrangement of the discrete plurality of heat exchangers has a greater predicted remaining useful life than the first unique arrangement of the discrete plurality of heat exchangers.

In certain embodiments, a system includes a controller of a reciprocating engine. The controller is configured to detect a threshold reduction in performance of at least one heat exchanger of a discrete plurality of heat exchangers coupled to an exhaust circuit of the reciprocating engine. The discrete plurality of heat exchangers is disposed in a first unique arrangement of coupling to the exhaust circuit, wherein each of the plurality of heat exchangers include the same connectors to couple to the exhaust circuit. The controller is also configured to generate an output indicative of a second unique arrangement of the discrete plurality of heat exchangers of coupling to the exhaust circuit. The second unique arrangement of the discrete plurality of heat exchangers has a greater predicted remaining useful life than the first unique arrangement of the discrete plurality of heat exchangers.

In certain embodiments, a system includes a reciprocating engine and an exhaust circuit coupled to the reciprocating engine. The exhaust circuit includes a discrete plurality of heat exchangers coupled with the exhaust circuit in different positions. The system also includes a controller configured to detect a threshold reduction in performance of at least one heat exchanger of the discrete plurality of heat exchangers coupled to the exhaust circuit of the reciprocating engine. The discrete plurality of heat exchangers is disposed in a first unique arrangement of coupling to the exhaust circuit, wherein each of the plurality of heat exchangers include the same connectors to couple to the exhaust circuit. The controller is also configured to generate an output indicative of a second unique arrangement of the discrete plurality of heat exchangers of coupling to the exhaust circuit. The second unique arrangement of the discrete plurality of heat exchangers has a greater predicted remaining useful life than the first unique arrangement of the discrete plurality of heat exchangers.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a diagram of an embodiment of a combustion system having a heat exchange system coupled to an exhaust system of engine system, wherein heat exchangers are coupled to a distribution manifold, and the heat exchangers are shuffled between various positions in a controlled manner.

FIG. 2 is a diagram of an embodiment of the combustion system of FIG. 1, further illustrating details of heat exchanger assemblies disposed in different positions of the exhaust system of the engine system.

FIG. 3 is a front view of an embodiment of the heat exchange system of FIGS. 1 and 2, illustrating details of a positioning system for moving one of the heat exchangers relative to a support system.

FIG. 4 is a side view of an embodiment of the heat exchange system of FIGS. 1-3, further illustrating details of the positioning system and the support system.

FIG. 5 is schematic view of an embodiment of the heat exchange system of FIGS. 1-4, further illustrating details of the heat exchangers in the heat exchanger assembly.

FIG. 6 is a perspective view of an embodiment of the heat exchanger of FIGS. 1-5, further illustrating details of a flange having a mounting interface with fluid connections and mechanical connections.

FIG. 7 is an exploded rear perspective view of an embodiment of the distribution manifold of FIGS. 1-4, further illustrating manifold portions with various fluid ports and connections to facilitate heat transfer between an exhaust gas and multiple fluids.

FIG. 8 is an exploded front perspective view of the distribution manifold of FIG. 7, further illustrated the fluid connections and mechanical connections for the heat exchangers.

FIG. 9 is a flow chart of an embodiment of a process for shuffling the heat exchangers between various positions in a combustion system.

FIG. 10 is a flow chart of an embodiment of a process for shuffling the heat exchangers between various positions in the combustion system.

FIG. 11 is a flow chart of an embodiment of a process for shuffling the heat exchangers between various positions in the combustion system.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

As discussed in detail below, various embodiments of a heat exchange system enable tracking and controlled positioning of a plurality of heat exchangers coupled to an internal combustion engine, such as a reciprocating internal combustion engine having a plurality of reciprocating pistons. The heat exchangers may be tracked with one or more identifiers coupled to each heat exchanger, and various heat exchanger information may be recorded in memory of one or more computing devices (e.g., computers, controllers, etc.). For each heat exchanger, the recorded information may include the identification, location, monitored parameters, service and maintenance data, or any combination thereof, for the particular heat exchanger at the present time and over the course of the heat exchanger's life. The monitored parameters and the service and maintenance data is discussed in further detail below. Accordingly, the recorded information may indicate the various monitored conditions for each position of the heat exchanger, trends in the monitored conditions over time, cleaning cycles, and projections regarding when a next movement may be recommended for the heat exchanger. The monitored conditions may be compared with one or more thresholds, which may be dependent on the current location of the heat exchanger. For example, one location may have a higher performance threshold compared to another location with a lower performance threshold. These different thresholds may be used to enabled controlled positioning of the heat exchangers from locations with higher performance thresholds to positions with lower performance thresholds, thereby extending the operating life of the heat exchanger prior to any cleaning cycle and/or removal from service.

Each of the plurality of heat exchangers may have common characteristics, such as a common geometry, common construction materials, a common mounting interface, and a common performance. For example, as discussed in detail below, the common geometry may include common outer dimensions (e.g., length, width, and height), common dimensions and numbers of individual components (e.g., common dimensions and numbers of plates), and common volumes (e.g., interior volumes for liquid and gas flows). The common construction materials may include use of the same materials (e.g., stainless steel, aluminum, copper, and/or one or more additional metals) for constructing the plates and mounting interface. By further example, the common mounting interface may include common connections (e.g., common fluid connections, common mechanical connections, etc.), such that the plurality of heat exchangers can be mounted in the same manner at each of the different locations. The common performance may include a common effectiveness for heat exchange, a common pressure drop between an exhaust inlet and an exhaust outlet, a common pressure drop between a fluid inlet and a fluid outlet, or any combination thereof. Each of these common characteristics is discussed in further detail below. In certain embodiments, the common characteristics may be substantially the same or identical between the plurality of heat exchangers.

In certain embodiments, the heat exchangers may be designed for the highest demand location (e.g., highest performance demands), such that the heat exchangers can be used in any of the locations, even though the heat exchangers may be substantially over sized for certain locations with lower demands (e.g., lower performance demands). As a result, as the performance of the heat exchanger decreases at a higher demand location, the heat exchanger is still suitable for use at a lower demand location, partially due to the different performance thresholds and partially due to the oversized design of the heat exchanger relative to the lower demand location. The heat exchanger may be sequentially moved to a plurality of different locations, each location having gradually lower performance demands and each location still benefiting from the reduced performance of the heat exchanger prior to any cleaning cycle. The heat exchangers may be moved by draining any heat transfer fluids (e.g., cooling water), mechanically disconnecting the heat exchangers (e.g., unbolting the heat exchangers), moving the heat exchangers to new positions, mechanically connecting the exchangers at the new positions (e.g., bolting the heat exchangers), and refilling the heat exchanger fluids. Eventually, after one or more moves, the heat exchanger may undergo a cleaning cycle, and then rejoin the shuffling of locations in the heat exchange system.

The shuffling of the heat exchangers may be controlled by the computing device based on a variety of fixed and changing data, including but not limited to, monitored conditions, service and maintenance data, user input, one or more guides or tables of recommended movements, computer models of the engine and heat exchange system, or any combination thereof. In certain embodiment, the recommended locations for the heat exchangers may be generated in real-time in view of all the data. The recommendations may be generated as an output, such as an output on the computing device (e.g., one or more messages on a display screen). A user can then operate a positioning system to move the heat exchangers between the different positions based on the recommendations. The following discussion presents embodiments of the heat exchange system in context of a combustion system, which may include any number of internal combustion engines, exhaust systems, and heat exchanger assemblies that can benefit from shuffling of the heat exchangers.

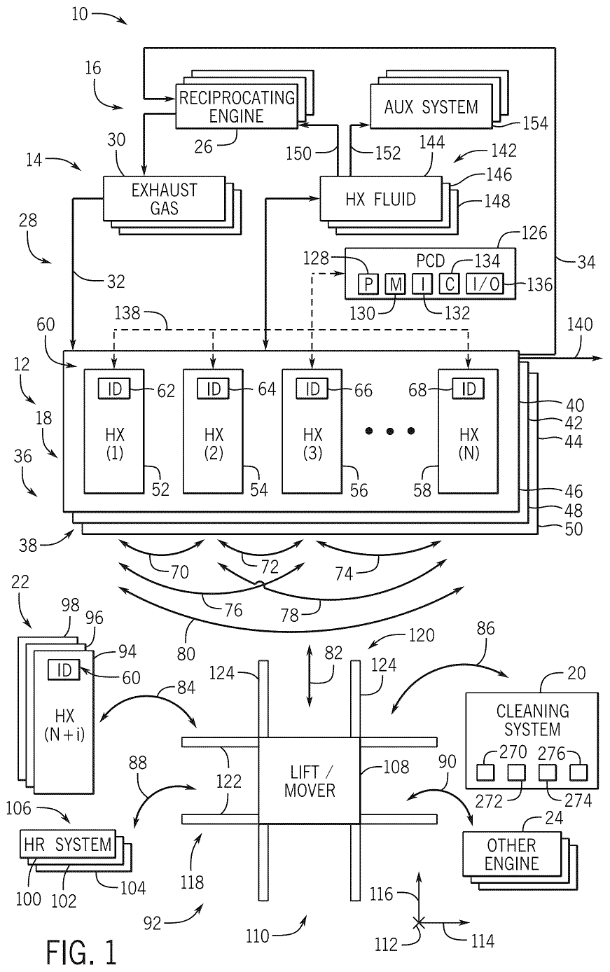

FIG. 1 is a diagram of an embodiment of a combustion system 10 having a heat exchange system 12 coupled to an exhaust system 14 of engine system 16. As discussed in detail below, the heat exchange system 12 is configured to enable a controlled shuffle or movement of a discrete plurality of heat exchangers 18 between various positions in the exhaust system 14 (e.g., EGR heat exchanger positions, exhaust gas waste heat recovery heat exchanger positions etc.) of one or more reciprocating engines 26, a cleaning system 20, a spare storage 22, and one or more additional reciprocating engines 24. The controlled shuffle or movement of the heat exchangers 18 is configured to extend the useful life of the heat exchangers 18 and increase the cumulative performance of all connected heat exchangers 18 by changing between a plurality of unique arrangements (e.g., 1, 2, 3, 4, 5, 6, 7, 8, 9, 10, or more unique arrangements) of coupling the heat exchangers 18 with the exhaust system 14 (e.g., exhaust circuit 28), wherein each change in the unique arrangements will help to increase the remaining useful life of the heat exchangers 18. For example, the heat exchangers 18 may be periodically moved to take advantage of the best performing heat exchangers 18 relative to the locations having the highest performance demands, while also taking advantage of the lower performing heat exchangers 18 in locations having lower performance demands. Various aspects of the controlled shuffle or movements of heat exchangers 18 are discussed in further detail below.

The changes in heat exchanger positions between different unique arrangements of the heat exchanger 18 are configured to provide a greater predicted remaining useful life of the heat exchangers 18. As an example, in certain embodiments, the useful life of the heat exchanger 18 may be calculated, estimated, or predicted based on one or more parameters, such as the cumulative time of operating the heat exchanger 18 before the performance (e.g., effectiveness) of the heat exchanger 18 is no longer able to meet a minimum performance threshold even after one or more cleaning procedures. If the heat exchanger 18 is no longer able to meet the minimum performance threshold, then it may be determined by a controller that the useful life of the heat exchanger 18 is over. Accordingly, when moving the heat exchangers 18 between first and second unique arrangements, the changes in positions of the heat exchangers 18 (e.g., the move from the first to the second unique arrangement) may be selected to provide a greater predicted remaining useful life of the heat exchangers 18 due to a number of reasons. For example, one of the heat exchangers 18 may be moved to a lower demand position, a cooler position, a lower pressure position, a lower flow position, a later stage in a multi-stage heat exchange assembly, a location with cleaner flows (e.g., cleaner exhaust flow), or any combination thereof, such that the heat exchanger 18 may be capable of operating for a longer duration of time than possible in the previous position of the heat exchanger 18. Other factors also may contribute to the heat exchanger 18 being capable of operating for longer durations of time. Accordingly, the foregoing reasons are intended only as non-limiting examples to help predict changes in the useful life of the heat exchangers 18. As a result, the second unique arrangement of the discrete plurality of heat exchangers 18 has a greater predicted remaining useful life than the first unique arrangement of the discrete plurality of heat exchangers 18.

The one or more reciprocating engines 24 and 26 may include the same or different reciprocating piston-cylinder internal combustion engines. Each of the reciprocating engines 24 and 26 may include a two-stroke engine, a four-stroke engine, or other type of reciprocating engine. In certain embodiments, each of the reciprocating engines 24 and 26 is a four-stroke engine. Each of the reciprocating engines 24 and 26 may also include any number of combustion chambers, pistons, and associated cylinders (e.g., 1-24) in one cylinder bank (e.g., inline) or multiple cylinder banks (e.g., left and right cylinder banks) of a V, W, VR (a.k.a. Vee-Inline), or WR cylinder bank configuration. For example, in certain embodiments, each of the reciprocating engines 24 and 26 may include a large-scale industrial reciprocating engine having 6, 8, 12, 16, 20, 24 or more pistons reciprocating in cylinders. In some such cases, the cylinders and/or the pistons may have a diameter of between approximately 13.5-31 centimeters (cm). In certain embodiments, the cylinders and/or the pistons may have a diameter outside of the above range. The fuel utilized by each of the reciprocating engines 24 and 26 may be any suitable gaseous fuel, such as natural gas, associated petroleum gas, hydrogen (Eh), propane (C₃H₈), biogas, sewage gas, landfill gas, coal mine gas, butane (C₄H₁₀), ammonia (NFE) for example. The fuel may also include a variety of liquid fuels, such as gasoline, diesel, methanol, or ethanol fuel. The fuel may be admitted through either a high pressure (blow-through) fuel supply system or low pressure (draw-through) fuel supply system or direct injection. In certain embodiments, each of the reciprocating engines 24 and 26 may utilize spark ignition. In other embodiments, each of the reciprocating engines 24 and 26 may utilize compression ignition. Each of the reciprocating engines 24 and 26 may be the same or different with respect to the size, number, and arrangement of pistons and cylinders, the ignition type (e.g., spark or compression ignition), the fuel type, the make and model, the exhaust system configuration (e.g., exhaust circuit layout, heat exchanger layout based on cooling requirements, EGR layout, exhaust gas waste heat recovery layout, etc.), and/or any other engine characteristics. Each of the reciprocating engines 24 and 26 may have the same or different exhaust flow characteristics and cooling needs, such as different EGR cooling needs depending on the engine designs and other considerations.

The exhaust system 14 may include one or more exhaust circuits 28 between each reciprocating engine 26 and the corresponding heat exchange system 12. The exhaust circuits 28 may be configured to route one or more flows of exhaust gas 30 between the reciprocating engine 26 and the heat exchange system 12. For example, each reciprocating engine 26 may output and route a flow of the exhaust gas 30 along an exhaust line 32 to the heat exchange system 12 and recirculate the exhaust gas 30 from the heat exchange system 12 back into the reciprocating engine 26 via one or more exhaust gas recirculation (EGR) lines 34.

The heat exchange system 12 coupled to the exhaust circuit 28 may include one or more heat exchanger assemblies 36, wherein each of the heat exchanger assemblies 36 includes a plurality of the heat exchangers 18 coupled to one of a plurality of distribution manifolds 38. For example, the heat exchanger assemblies 36 may include heat exchanger assemblies 40, 42, and 44, wherein each of the heat exchanger assemblies 36 includes one of the distribution manifolds 38 (e.g., distribution manifolds 46, 48, and 50). Each of the heat exchanger assemblies 36 may include any number of the heat exchangers 18 disposed in a series arrangement, a parallel arrangement, or a combination thereof. For example, in certain embodiments, the heat exchangers 18 for each of the heat exchanger assemblies 36 having one of the distribution manifolds 38 may include heat exchangers 52, 54, 56, and 58. Although four heat exchangers 52, 54, 56, and 58 are shown, any number of heat exchangers (e.g., up to an Nth heat exchanger) may be disposed in each of the heat exchanger assemblies 36. The heat exchangers 52, 54, 56, and 58 may be arranged in series, in parallel, or a combination thereof. In certain embodiments, the heat exchangers 52 and 54 may be first stage heat exchangers (e.g., arranged in parallel), the heat exchanger 56 may be a second stage heat exchanger, and the heat exchanger 58 may be a third stage heat exchanger. However, the heat exchangers 18 may be arranged in any number of stages, each stage having 1, 2, 3, or more heat exchangers arranged in parallel with one another.

The illustrated heat exchanger assemblies 40, 42, and 44 each have one of the distribution manifolds 46, 48, and 50 having a plurality of the heat exchangers 18, such as the heat exchangers 52, 54, 56, and 58. The heat exchanger assemblies 40, 42, and 44 may have the same or different configuration of the heat exchangers 18 and the distribution manifolds 38, such as the same or different numbers of the heat exchangers 18, the same or different numbers of sections making up the distribution manifolds 38, or any combination thereof. Each of the distribution manifolds 38 may represent a single one-piece distribution manifold (e.g., single cast manifold), a multi-piece distribution manifold (e.g., sectional cast manifold) having different manifold portions removably coupled together, or individual conduits coupling together the heat exchangers 18 as a multi-conduit distribution manifold.

Each of the heat exchangers 18 also includes one or more identifier 60 disposed on the respective heat exchanger 18. For example, the identifier 60 may include identifiers 62, 64, 66, and 68 disposed on the respective heat exchangers 52, 54, 56, and 58. The identifiers 60 may include human-readable identifiers, machine-readable identifiers, or any combination thereof. For example, the identifiers 60 may include serial numbers, bar codes, radio-frequency identification (RFID) tags, smart tags, quick response (QR) codes (e.g., two-dimensional or matrix barcodes), numeric identifiers, alphanumeric identifiers, color-coded identifiers, computer-readable chips (e.g., integrated circuit chip), or any combination thereof. The identifiers 60 may be coupled to the heat exchangers 18 by at least one of: (a) directly marking, stamping, printing, scribing, etching, or forming the identifiers 60 in or on a surface of the heat exchangers 18, (b) removably or fixedly mounting a tag, plate, or card with the identifiers 60 to the heat exchangers 18, or (c) any combination thereof. As discussed in further detail below, the identifiers 60 are used to track the heat exchangers 18 when moving the heat exchangers between different positions within the combustion system 10, while also correlating monitored feedback from sensors, service history, user input, cleaning history, or any combination thereof.

As illustrated, the heat exchangers 18 may be shuffled or generally moved between different positions as indicated by arrows 70, 72, 74, 76, 78, 80, 82, 84, 86, 88, and 90. For example, arrow 70 illustrates movement of the heat exchangers 18 to change positions of the heat exchangers 52 and 54. Arrow 72 illustrates movements of the heat exchangers 18 to change positions of the heat exchangers 54 and 56. Arrow 74 illustrates movements of the heat exchangers 18 to change positions of the heat exchangers 56 and 58. Arrow 76 illustrates movements of the heat exchangers 18 to change positions of the heat exchangers 52 and 56. Arrow 78 illustrates movements of the heat exchangers 18 to change positions of the heat exchangers 54 and 58. Arrow 80 illustrates movements of the heat exchangers 18 to change positions of the heat exchangers 52 and 58. Arrow 82 illustrates movements of one or more of the heat exchangers 18 between one of the heat exchanger assemblies 36 and a positioning system 92. Arrow 84 illustrates movements of the heat exchangers 18 to and from the spare storage 22 via the positioning system 92, wherein the spare storage 22 may include heat exchangers 94, 96, or 98. Arrow 86 illustrates movements of the heat exchangers 18 to and from the cleaning system 20 via the positioning system 92. Arrow 88 illustrates movements of the heat exchangers 18 to and from one or more heat recovery systems 100, 102, and 104 of an exhaust gas waste heat recovery system 106 via the positioning system 92. Arrow 90 illustrates movements of the heat exchangers 18 to and from one or more of the other engines 24 via the positioning system 92.

The positioning system 92 may be used to move the heat exchangers 18 between all of the illustrated positions or locations, such as locations in each of the heat exchanger assemblies 36 (e.g., 40, 42, and 44), the cleaning system 20, the spare storage 22, the other engines 24, and the exhaust gas waste heat recovery system 106. The positioning system 92 may include any type and configuration of equipment suitable for moving the heat exchangers 18, including but not limited to forklifts, overhead cranes, overhead hoists, floor mounted hoists, wheeled carts, robotic arms, rail mounted positioning systems, or any combination thereof. The positioning system 92 may be operated by a user and/or controlled by a control system. The positioning system 92 may include any number of drives (e.g., electric drives, fluid drives, etc.) to provide movement in horizontal and/or vertical directions to move the heat exchangers 18.

As a non-limiting example, the positioning system 92 includes a lift/mover 108 coupled to a rail assembly 110. For example, the lift/mover 108 may include one or more drives configured to move along one or more axes, such as axes 112, 114, and 116. The axes 112, 114, and 116 may correspond to a respective vertical axis or direction 112, a horizontal axis or direction 114, and a horizontal axis or direction 116. The vertical axis 112 is generally perpendicular to the horizontal axes 114 and 116, and the horizontal axes 114 and 116 are generally perpendicular relative to one another. The rail assembly 110 may include a rail assembly 118 extending along or parallel with the horizontal axis 114, and a rail assembly 120 extending along or parallel with the horizontal axis 116. In the illustrated embodiment, each of the rail assemblies 110 (e.g., 118 and 120) may include one or more rail structures to facilitate movement along one of the axes. For example, the rail assembly 118 may include rails 122 and the rail assembly 120 may include rails 124. The rails 122, such as a pair of parallel rails, may be parallel to the horizontal axis 114 and perpendicular to the horizontal axis 116. Similarly, the rails 124, such as a pair of parallel rails, may be parallel to the horizontal axis 116 and perpendicular to the horizontal axis 114. The lift/mover 108 may be configured to move along the rail assembly 118 in the horizontal axis or direction 114, along the rail assembly 120 in the horizontal axis or direction 116, or a combination thereof. The lift/mover 108 may include one or more drives configured to facilitate movement along each of the rail assemblies 118 and 120. The lift/mover 108 may include one or more drives configured to enable upward and downward movements along the vertical axis or direction 112. As discussed in further detail below, the lift/mover 108 may include a heat exchanger interface (e.g., mount, connection, harness, etc.) configured to couple to one of the heat exchangers 18, such that the positioning system 92 is able to lift and move the heat exchanger 18 between the various positions in the combustion system 10.

As discussed above, the heat exchangers 18 include identifier 60 configured to provide identification of each heat exchanger 18 when undergoing movements between different positions. Additionally, a portable computing 126 may be provided to facilitate tracking of the heat exchangers 18 via the identifiers 60. For example, the portable computing device 126 may include a portable computer, a smart phone, a tablet computer, a laptop computer, a handheld electronic device, a smart watch, or other portable electronic device. The portable computing device 126 may be sufficiently portable to enable a technician to move around a facility (e.g., in an area of the combustion system 10), read or input the identifier 60, record data, and facilitate the movements of heat exchangers 18 between different positions.

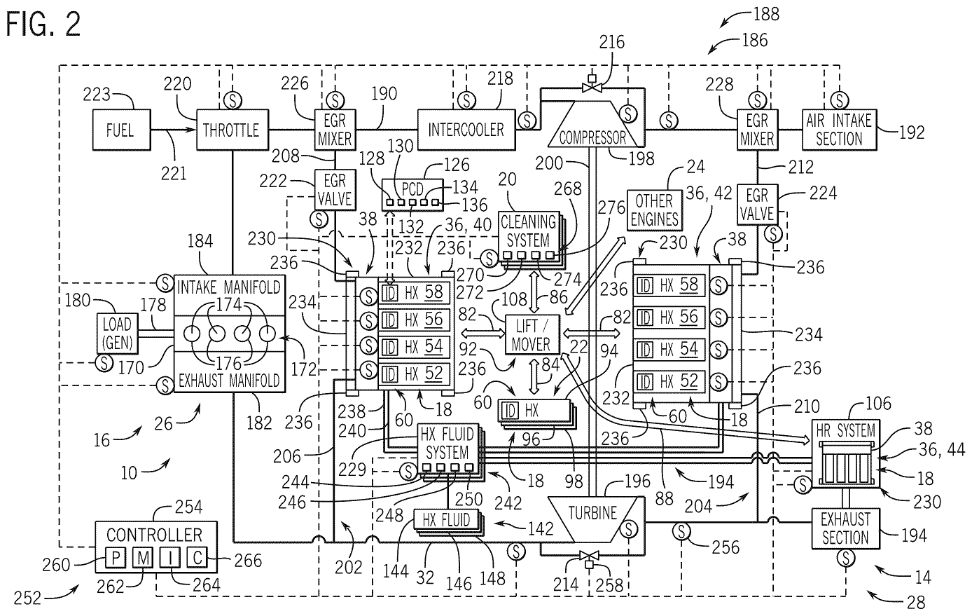

In the illustrated embodiment, the portable computing device 126 includes one or more processors 128, memory 130, instructions 132 stored on the memory 130 and executable by the processor 128, communication circuitry 134, and one or more input/output devices 136. For example, the instructions 132 may be configured to guide a user to input data, scan the identifier 60 on heat exchangers 18, record changes and positions of the heat exchangers 18 via the input/output device 136, and generate an output (e.g., message on a display screen) with a recommendation for the various positions for the heat exchangers 18. The communication circuitry 134 may include wired or wireless communication circuitry configured to enable transmission of data to and from the portable computing device 126, a controller (e.g., controller 254 of FIG. 2), a remote server or computer, a cloud-based system, or any combination thereof. The input/output device 136 may include a display screen (e.g., a touch screen), a keypad or keyboard, a pointing device (e.g., mouse, trackball, joystick, touchpad, etc.), a microphone, speakers, a digital camera, a scanner for the identifiers 60 (e.g., separate from or integrated with the digital camera), visual indicators, or any combination thereof. Again, the portable computing device 126 is configured to enable tracking of the heat exchangers 18 when making movements by using the identifier 60, while also providing recommendations for possible changes in positions of the heat exchangers 18. Additional details for the recommended changes in positions of the heat exchangers 18 are discussed in further detail below. As indicated by dashed arrows 138, the portable computing device 126 may obtain the identifier 60 information via scanning, manual data input, wireless communication, or any combination thereof, to input the identifier 60 into the memory 130 of the portable computing device 126.

In the illustrated embodiment, each heat exchanger assembly 36 includes a plurality of the heat exchangers 18, such as a series arrangement of the heat exchangers 52, 54, 56, and 58, coupled to at least one of the distribution manifolds 38. The heat exchangers 18 are also coupled to the exhaust line 32 and the EGR line 34 of the exhaust circuit 28 of the exhaust system 14 through the at least one distribution manifold 38. A flow of the exhaust gas 30 is configured to flow from one or more of the reciprocating engines 26 through the exhaust line 32 into one of the distribution manifolds 38, through the heat exchangers 18, back through one of the distribution manifolds 38, and then through the EGR line 34 for recirculation into an intake of the reciprocating engine 26. In some embodiments, at least part or all of the exhaust gas 30 may not flow back into the reciprocating engine 26 via the EGR line 34. For example, at least part of the exhaust gas 30 may discharge from the heat exchanger assembly 36 and flow downstream into one of the exhaust gas waste heat recovery systems 106 and/or discharge into the environment as indicated by arrow 140.

Each distribution manifold 38 is configured to circulate the exhaust gas 30 from the reciprocating engine 26 through each of the heat exchangers 18, such as in a series arrangement and/or a parallel arrangement, while also circulating one or more heat exchange fluids 142 through the distribution manifold 38 and the heat exchangers 18. For example, the heat exchange fluids 142 may include heat exchange fluids 144, 146, and 148. The heat exchange fluids 142 may include one or more liquids, such as water, antifreeze liquids or additives, coolants, or any combination thereof. For example, the heat exchange fluids 142 may include a main engine fluid 150 and an auxiliary fluid 152. As illustrated, the main engine fluid 150 may flow to, from, and through the reciprocating engine 26, such that the main engine fluid 150 may be configured to provide cooling of the reciprocating engine 26. Similarly, the auxiliary fluid 152 may pass to and from one or more auxiliary systems 154, such that the auxiliary fluid 152 may provide cooling. The auxiliary systems 154 may be related and/or unrelated to the reciprocating engine 26, but the auxiliary systems may be outside or separate from the reciprocating engine 26. For example, auxiliary systems 154 may include other power plant equipment, and the auxiliary fluid 152 may be described as a balance of plant (BoP) fluid (e.g., BoP auxiliary water)). Again, for each heat exchanger assembly 36, the distribution manifold 38 may be configured to route inputs and outputs of both the exhaust gas 30 and the heat exchange fluids 142 (e.g., the main engine fluid 152 and/or the auxiliary fluid 152) through each of the heat exchangers 18.

Accordingly, the heat exchanger assemblies 36 may transfer heat between the exhaust gas 30 and one or more of the heat exchange fluids 142, such as the main engine fluid 150 and the auxiliary fluid 152. The heat exchangers 18 may be gas liquid heat exchangers, which are configured to transfer heat between the exhaust gas 30 and the liquid of the heat exchange fluids 142. In some embodiments, each of the heat exchangers 18 may be a plate heat exchanger, a brazed plate heat exchanger, and/or a gas-to-liquid plate heat exchanger, such as manufactured by Alfa Laval of Lund, Sweden. For example, the heat exchangers 18 may be Alfa Laval model GL150 heat exchangers. The heat exchangers 18 may be sealed for life to provide low maintenance, and the heat exchangers 18 may be cleaned via a clean-in-place (CIP) procedure, wherein the heat exchangers 18 are cleaned without any disassembly by flushing a cleaning fluid through the internal flow passages.

Each of the plurality of heat exchangers 18 may have common characteristics, such as a common geometry, common construction materials, a common mounting interface, and a common performance. For example, as discussed in detail below, the common geometry may include common outer dimensions (e.g., length, width, and height), common dimensions and numbers of individual components (e.g., common dimensions and numbers of plates), and common volumes (e.g., interior volumes for liquid and gas flows). In certain embodiments, the heat exchangers 18 may be sized substantially or exactly the same as one another, such that the heat exchangers 18 generally provide the same heat transfer capacities when in the same condition, such as in a new condition, a cleaned condition, or a condition with equal usage in the combustion system 10. The common construction materials may include use of the same materials (e.g., stainless steel, aluminum, copper, and/or one or more additional metals.) for constructing the plates and mounting interface. By further example, the common mounting interface may include common connections (e.g., common fluid connections, common mechanical connections, etc.), such that the plurality of heat exchangers 18 can be mounted in the same manner at each of the different locations. The common fluid connections may include the same number, size, and relative positioning of fluid connections. The common fluid connections may include common input and output fluid ports (e.g., fluid connection ins and outs), such as exhaust input and output ports coupled to an internal exhaust flow path of the heat exchanger 18, main fluid input and output ports coupled to an internal main fluid flow path of the heat exchanger 18, and auxiliary fluid input and output ports coupled to an internal auxiliary fluid flow path of the heat exchanger 18. The common mechanical connections may include the same number, size, and relative positioning of mechanical connections, such as threaded fasteners (e.g., threaded bolts and/or threaded receptacles). The common performance may include a common effectiveness for heat exchange, a common pressure drop between an exhaust inlet and an exhaust outlet, a common pressure drop between a fluid inlet and a fluid outlet, or any combination thereof. In certain embodiments, the common characteristics may be substantially the same or identical between the plurality of heat exchangers 18. For example, the heat exchangers 18 may be substantially the same or identical heat exchangers 18 designed for the highest performance demands for all possible positions in the combustion system 10. Any discussion of these common characteristics in the present application is intended to cover the foregoing aspects and any additional characteristics discussed herein.

As discussed in further detail below, the movements of heat exchangers 18 throughout the combustion system 10 may be based on changes in performance in heat exchangers 18, such that if a low performing heat exchanger is no longer suitable for a certain position, that heat exchanger may be moved to another location with lower thresholds for performance, such that the heat exchanger 18 can continue to be used in the combustion system 10 at a reduced performance level. Overall, the movements of the heat exchangers 18 are configured to maximize the usage of each heat exchanger 18 taking in account reductions in performance of each heat exchanger 18 and different performance demands at different positions throughout the combustion system 10. The parameters used to evaluate performance of the heat exchangers 18 may include any of the parameters disclosed herein. For example, a non-limiting description of the parameters is presented below in the discussion of FIG. 2

In certain embodiments, the movements of the heat exchangers 18 may be based on conditions or logic set forth in a look-up table, a computer model, or other computer-implemented control. As an example, the following Table 1 depicts an embodiment of logic for recommended movements of the heat exchangers 18. As indicated below, HX(1) corresponds to a first EGR cooling stage (e.g., high temperature non-condensing cooler) such as heat exchanger 52 or 54, HX(2) corresponds to a second EGR cooling stage (e.g., low temperature condensing cooler) such as heat exchanger 56, and HX(3) corresponds to a third EGR cooling stage (e.g., reheater) such as heat exchanger 58. The off-engine cleaning corresponds to cleaning of the heat exchanger 18 via the cleaning system 20. The other use (e.g., exhaust gas heat recovery) may correspond to the exhaust gas waste heat recovery system 106. The ready-spare may correspond to the spare storage 22. The letters A, B, C, D, E, and F correspond to the unique identifiers 60 for the different heat exchangers 18. Each row indicates a unique arrangement of the heat exchangers 18 as indicated by the movements of the heat exchangers 18 corresponding to the unique identifiers 60 (e.g., A, B, C, D, E, and F).

TABLE 1
Heat Exchanger Swap Logic

| | | | | | Other use | | |
|---|---|---|---|---|---|---|---|
| | | | | | (e.g., | | |
| | | | | Off- | exhaust | | |
| Swap | | | | Engine | gas heat | Ready- | |
| Example | HX(1) | HX(2) | HX(3) | Cleaning | recovery) | Spare | Logic |
| Initial | A | B | C | D | E | F | Baseline |
| | | | | | | | configuration |
| | | | | | | | for later |
| | | | | | | | swapping |
| | | | | | | | sequence |
| | | | | | | | operations |
| 1 | A | C | B | D | E | F | Potential |
| | | | | | | | Corrosion of |
| | | | | | | | HX(2) from |
| | | | | | | | condensate |
| 2 | B | A | C | D | E | F | Desire for |
| | | | | | | | pyrolysis |
| | | | | | | | cleaning of |
| | | | | | | | HX(2) |
| | | | | | | | condensing |
| | | | | | | | wet fouling |
| | | | | | | | in non- |
| | | | | | | | condensing |
| | | | | | | | temperature |
| 3 | B | C | A | D | E | F | HX(1) |
| | | | | | | | temperature |
| | | | | | | | fatigue life |
| | | | | | | | damage |
| | | | | | | | limited. |
| | | | | | | | HX(3) |
| | | | | | | | moderate |
| | | | | | | | temperature |
| | | | | | | | strains good |
| | | | | | | | for end of |
| | | | | | | | life. |
| 4 | C | A | B | D | E | F | Healthiest |
| | | | | | | | used cooler |
| | | | | | | | to HX(1). |
| 5 | C | B | A | D | E | F | HX(1) |
| | | | | | | | temperature |
| | | | | | | | fatigue life |
| | | | | | | | damage |
| | | | | | | | limited. |
| | | | | | | | HX(3) |
| | | | | | | | moderate |
| | | | | | | | temperature |
| | | | | | | | strains good |
| | | | | | | | for end of |
| | | | | | | | life. |
| 6 | A | D | C | B | E | F | Normal |
| | | | | | | | cleaning |
| | | | | | | | exchange. |
| 7 | A | B | E | D | C | F | If EGHE |
| | | | | | | | near end of |
| | | | | | | | life as HX(3) |
| | | | | | | | moderate |
| | | | | | | | temperature |
| | | | | | | | strains good |
| | | | | | | | for end of |
| | | | | | | | life. |
| 8 | F | B | C | D | E | A | On-engine |
| | | | | | | | cooler failure |
| | | | | | | | replacement |
| | | | | | | | to minimize |
| | | | | | | | downtime. |
| 9 | A | B | C | E | D | F | Cleaning of |
| | | | | | | | EGHE |
| | | | | | | | cooler |
| | | | | | | | independent |
| | | | | | | | of on-engine |
| | | | | | | | status. |
| 10 | A | B | C | E | F | D | Cleaning of a |
| | | | | | | | ready spare. |

As indicated above, the heat exchangers 18 may be moved to various positions based on different unique arrangements in response to different conditions or logic, while using the unique identifiers 60 (e.g., A, B, C, D, E, and F) to track the positions of the heat exchangers 18. In certain embodiments, the number of permutations (without repetition and where order is important) may be represented by the following equation (1), wherein n=Set (choose from) and r=Sub-Set (chosen).

$${P}_{( n , r )} = \frac{n !}{( n - r ) !}$$

In certain embodiments, as discussed in the present drawings and description, the heat exchanger performance may include an effectiveness of the heat exchanger. For example, the heat exchanger effectiveness, ε, is a dimensionless parameter defined as the ratio of the actual heat transfer to the heat transfer attainable in an infinitely long (infinite surface area) counterflow exchanger; the maximum heat transfer thermodynamically possible in ideal conditions as if one fluid underwent a temperature change equal to the maximum temperature difference available. Effectiveness is used to eliminate the unknown variable of the discharge temperature, in addition to fluid and flow states, such that three temperatures per heat exchanger may be used for the calculations. The magnitude of the effectiveness can range from 0 (no heat transfer at all) to 1 (maximum possible heat transfer for the given fluid inlet temperatures, the flow rates, and specific heats). A counterflow heat exchanger has the highest effectiveness of a heat exchanger or flow arrangement, and a parallel flow heat exchanger has the lowest. All other flow arrangements fall between these two.

The effectiveness calculation may be based on a number of assumptions as follows. The effectiveness calculation may be applied for each stage of the EGR cooling system, such as HX(1), HX(2), and HX(3). Sensor feedback may be acquired for at least each stage (e.g., HX(1), HX(2), and HX(3)); however, each heat exchanger 18 may be monitored by one or more sensors if feasible. In certain embodiments, HX(1) and HX(3) may be assumed to be in the same fluid circuit. The heat exchangers 18 may be assumed to be adiabatic (i.e., there is no heat loss to the surroundings) and all heat exchange is from the hot fluid to the cold fluid. Additional assumptions include perfect mixing in each heat exchanger passage (i.e., there is no temperature gradient normal to the flow direction) and negligible longitudinal conduction in the walls or fluids. In context of the present application, any reference to performance or performance levels of the heat exchangers 18 may include effectiveness of the heat exchangers 18 as one non-limiting example.

FIG. 2 is a diagram of an embodiment of the combustion system 10 of FIG. 1, further illustrating details of the heat exchanger assemblies 36 disposed in different positions of the exhaust system 14 of the engine system 16. In the illustrated embodiment, the heat exchanger assemblies 36 are disposed in three different locations throughout the exhaust system 14, as indicated by heat exchanger assemblies 40, 42, and 44. The heat exchangers 18 (e.g., 52, 54, 56, and 58) may be shuffled within each individual heat exchanger assembly 36 (e.g., 40, 42, and 42), between the different heat exchanger assemblies 36 (e.g., 40, 42, and 42), between different engines (e.g., 24 and 26), and between various applications (e.g., EGR cooling, waste heat recovery, etc.). The heat exchangers 18 (e.g., 52, 54, 56, and 58) also may be moved on and off of the engine 26, such as for cleaning in the cleaning 20 and/or swapping with spares in the spare storage 22. The movements of the heat exchangers 18 is configured to increase overall performance (e.g., effectiveness of the heat exchangers) in the various locations by moving heat exchangers 18 to generally use any remaining useful life of the heat exchangers 18 as performance decreases over time. Eventually, the heat exchangers 18 may be cleaned to increase their performance, but the heat exchangers 18 can move to multiple positions on the engine 26 without undergoing cleaning by taking advantage of the different performance demands at the different positions in the exhaust system 14.

The reciprocating engine 26 includes an engine block 170 having a plurality of piston-cylinder assemblies 172, each having a piston 174 disposed within a cylinder 176. Each piston 174 is configured to reciprocate within the cylinder 176 in response to combustion in a combustion chamber of the engine block 170, thereby driving rotation of a crankshaft coupled to a shaft 178 driving a load 180 (e.g., an electric generator). Additionally, the reciprocating engine 26 includes an exhaust manifold 182 and an intake manifold 184. The intake manifold 184 is coupled to an intake circuit 186 of an intake system 188, while the exhaust manifold 182 is coupled to the exhaust circuit 28 of the exhaust system 14. The intake circuit 186 includes one or more intake lines 190 extending between an air intake section 192 and the intake manifold 184, thereby supplying air into the reciprocating engine 26. For example, the air intake section 192 may include an air intake duct, air filters, or other features to process the air coming into the intake system 188.

The exhaust system 14 has one or more exhaust lines 32 extending between an exhaust section 194 and the exhaust manifold 182. For example, the exhaust section 194 may include a silencer, a catalytic converter, a discharge duct, or other equipment to facilitate discharge of the exhaust gas into the environment. As noted above, the exhaust system 14 also may include one or more EGR lines 34 to facilitate exhaust gas recirculation between the exhaust circuit 28 and the intake circuit 186. For example, the EGR lines 34 may include one or more EGR lines upstream and/or downstream of a turbocharger 194, which includes a turbine 196 disposed along the exhaust line 32, a compressor 198 disposed along the intake line 190, and a shaft 200 coupling together the turbine 196 and the compressor 198. The turbocharger 194 is driven by exhaust gas passing through the exhaust line 32 and through the turbine 196, which in turn rotates the shaft 200 coupled to the compressor 198. The compressor 198 operates to compress an airflow from the air intake section 192 flowing along the intake line 190 into the intake manifold 184.

As noted above, the EGR lines 34 may include EGR lines both upstream and downstream of the turbocharger 194. For example, the exhaust circuit 28 may include an exhaust gas recirculation (EGR) circuit 202 and an EGR circuit 204 disposed at different positions upstream and downstream relative to the turbocharger 194. In the illustrated embodiment, the EGR circuit 202 has EGR lines 206 and 208 coupled to the respective exhaust line 32 and the intake line 190, wherein the EGR lines 206 and 208 also couple to one of the heat exchanger assemblies 36 (e.g., the heat exchanger assembly 40). Similarly, the EGR circuit 204 has EGR lines 210 and 212 coupled to the respective exhaust line 32 and the intake line 190, wherein the EGR lines 210 and 212 also couple to one of the heat exchanger assemblies 36 (e.g., the heat exchanger assembly 42). In the illustrated embodiment, the EGR circuit 202 may be described as a high pressure EGR circuit, due to its location upstream from the turbine 196, whereas the EGR circuit 204 may be considered a low pressure EGR circuit based on its position downstream from the turbine 196. The exhaust system 14 may include one or more of the heat recovery systems, such as the exhaust gas waste heat recovery system 106 having one of the heat exchanger assemblies 36 (e.g., the heat exchanger assembly 44). As discussed in further detail below, the heat exchangers 18 in each of the heat exchanger assemblies 36 (e.g., heat exchanger assemblies 40, 42, and 44) may be moved relative to one another, moved to the cleaning system 20, moved to the spare storage 22, moved to other engines 24, removed from service in the combustion system 10, or any combination thereof using the positioning system 92.

The combustion system 10 of FIG. 2 may include a variety of components along the exhaust system 14 and the intake system 188. As discussed above, the turbine 196 of the turbocharger 194 is disposed along the exhaust line 32 of the exhaust system 14. The turbocharger 194 also may include a bypass valve or waste gate valve 214 configured to open and close to vary a bypass of exhaust gas around the turbine 196. The exhaust section 194 also may include various components, such as the silencer, catalytic converter, or other exhaust gas treatment components.

Similarly, the intake system 188 may include a bypass valve 216 configured to open and close to vary a bypass flow of air intake around the compressor 198. The intake circuit 186 of the intake system 188 may include an intercooler 218 configured to control the temperature of the air intake and a throttle 220 configured to control the flow of the air intake and fuel 221 from a fuel supply 223 into the intake manifold 184. For example, the intercooler 218 may be a heat exchanger configured to transfer heat away from the intake air after compression in the compressor 198, thereby cooling the compressed air to a suitable temperature prior to intake into the reciprocating engine 26 via the intake manifold 184. The throttle 220 also may be configured to control the fluid flows (e.g., air, recirculate exhaust gas, and fuel) into the intake manifold 184 downstream from the intercooler 218. The air intake section 192, as discussed above, may include air filters, intake ducts, or other equipment to properly intake and route the air flow into the reciprocating engine 26.

Each of the EGR circuits 202 and 204 is configured to recirculate an exhaust gas being discharged along the exhaust line 32 into the intake line 190 for return into the intake manifold 184 of the reciprocating engine 26. Each of the EGR circuits 202 and 204 includes an EGR valve, such as EGR valves 222 and 224, configured to regulate the flow of exhaust gas back into the reciprocating engine 26 through the respective circuits 101 and 204. Downstream from the EGR valves, the EGR circuits 202 and 204 may include an EGR mixer, such as EGR mixers 226 and 228. The EGR mixers 226 and 228 are configured to mix the EGR flow (e.g., the exhaust gas) with the incoming air from the air intake section 192. The EGR mixers 226 and 228 mix the exhaust gas and air prior to delivery into the reciprocating engine 26 via the intake manifold 184. The EGR mixer 226 mixes the exhaust gas and air downstream from the compressor 198 of the turbocharger 194, whereas the EGR mixer 228 mixes the exhaust gas in the air upstream from the compressor 198 of the turbocharger 194.

In certain embodiments, the combustion system 10 may include only one or both of the EGR circuits 202 and 204 and the respective heat exchanger assemblies 36. Each of the heat exchanger assemblies 36, such as the heat exchanger assemblies 40 and 42, is configured to transfer heat away from the exhaust gas and into one or more heat exchange fluids 142 of a heat exchanger fluid system 229. For example, as discussed above, the heat exchange fluids 142 may include a main engine fluid 150 and/or an auxiliary fluid 152. The heat exchanger assemblies 36 transfer heat away from the exhaust gas into the heat exchange fluids 142 of the heat exchanger fluid system 229, thereby cooling the exhaust gas prior to recirculating the exhaust gas back into the intake manifold 184 of the reciprocating engine 26. The heat exchanger assemblies 36 (e.g., heat exchanger assemblies 40 and 42) may be described as EGR cooling systems, such as multi-stage EGR cooling systems that provide EGR cooling in a plurality of stages.

Again, as discussed above with reference to FIG. 1, each of the heat exchanger assemblies 36 (e.g., heat exchanger assemblies 40 and 42) includes a plurality of the heat exchangers 18, such as heat exchangers 52, 54, 56, and 58, disposed in series and/or parallel along the EGR circuit 202 or 204. The heat exchangers 18 are coupled to one of the distribution manifolds 38, which in turn couples with the EGR lines 206 and 208 of the EGR circuit 202 or the EGR lines 210 and 212 of the EGR circuit 204. In the EGR circuit 202, the EGR line 206 directs the exhaust gas from the exhaust line 32 into the manifold 38, while the EGR line 208 receives a discharge of the exhaust gas from the distribution manifold 38 and returns the exhaust gas into the intake line 190. The EGR circuit 204 has the EGR line 210 coupled to an intake of the distribution manifold 38, while the EGR line 212 couples to a discharge of the distribution manifold 38 and returns the exhaust gas to the intake line 190. Similarly, the exhaust gas waste heat recovery system 106 has one of the heat exchanger assemblies 36 (e.g., heat exchanger assembly 44) coupled to the exhaust section 194 to facilitate waste heat recovery using the heat exchangers 18. The heat exchanger assembly 44 of the exhaust gas waste heat recovery system 106 may include any number of the heat exchangers 18 in series, in parallel, or a combination thereof, in a similar manner as the heat exchangers 18 in the EGR circuits 202 and 204.

In each of the heat exchanger assemblies 36, the manifold 38 and the heat exchangers 18 may be coupled together and supported by a support system 230. The support system 230 may be the same or different in each of the heat exchanger assemblies 36. However, the support system 230 may include one or more of the same or similar components. For example, the support system 230 may include a horizontal support, slab or table 232, a vertical support or backrest 234, and a plurality of legs 236. The horizontal support 232 is configured to support the heat exchangers 18, the vertical support 234 is configured to support the distribution manifold 38, and the legs 236 are coupled to the horizontal support 232 and extend to the ground to support the entire support system 230 at a vertical distance above the ground. In certain embodiments, the support system 230 may include a sliding frame or support (e.g., a horizontal sliding support), which is configured to help movement the heat exchangers 18. For example, the horizontal sliding support may be part of the horizontal support 232.

In operation, each of the heat exchanger assemblies 36 directs the exhaust gas into the distribution manifold 38, which then directs the exhaust gas through each of the heat exchangers 18 in a parallel configuration, a series configuration, or a combination thereof, followed by discharge of the exhaust gas from the distribution manifold 38 back into the intake system 188. Simultaneously, the distribution manifold 38 receives one or more heat exchange fluids 140 from the heat exchanger fluid system 229 via a line 238, circulates the one or more heat exchange fluids 142 through the heat exchangers 18 in a series arrangement, parallel arrangement, or a combination thereof, followed by discharge of the one or more heat exchange fluids 142 from the distribution manifold 38 back to the heat exchanger fluid system 229 as indicated by line 240. The lines 238 and 240 may represent one or more fluid lines depending on the number of heat exchange fluids 142. For example, if the heat exchanger fluid system 229 incorporates the main engine fluid 150 and auxiliary fluid 152 as two of the heat exchange fluids 142, then the line 238 may include at least two heat exchanger fluid supply lines into the distribution manifold 38, while the line 240 may include at least two or more fluid discharge lines to receive the heat exchange fluids 142 from the distribution manifold 38 back into the heat exchanger fluid system 229. This discussion of the heat exchanger fluid system 229 may be the same or substantially the same for each of the EGR circuits 202 and 204. Similarly, the heat exchanger assembly 36, 44 of the exhaust gas waste heat recovery system 106 may include a similar arrangement of heat exchangers 18, and a similar heat transfer between the heat exchange fluids 142 and the exhaust gas.

The heat exchanger fluid system 229 may include one or more components 242, such as components 244, 246, 248, and 250. The components 242 may include any number of components to control fluid flow in and out of the heat exchanger assembly 36. For example, the component 234 may include one or more fluid pumps, the component 246 may include one or more control valves, the component 248 may include one or more filters or fluid treatment units, and the component 250 may include one or more sensors or flow meters. In certain embodiments, one common heat exchanger fluid system 229 may be shared among each of the heat exchanger assemblies 36. However, in some embodiments, a dedicated or independent heat exchanger fluid system 229 may be coupled to each of the heat exchanger assemblies 36, such as each of the heat exchanger assemblies 40, 42, and 44.

As further illustrated in FIG. 2, the combustion system 10 may include a control system 252 having a controller 254 coupled to a plurality of sensors 256 and actuators 258 distributed about the combustion system 10. For example, the sensors 256, designated as “S,” may be coupled to the combustion system 10 at various locations along the exhaust system 14, the intake system 188, the EGR circuit 202, the EGR circuit 204, the turbocharger 194, the reciprocating engine 26, and the heat exchanger assemblies 36. Each of these sensors 256 may be configured to measure one or more parameters, which may be collectively used by the controller 254 to identify parameters and/or conditions suitable to trigger changes in the positions of the heat exchangers 18 throughout the combustion system 10. For example, the sensors 256 may be used to monitor changes in each of the following parameters between inlets and outlets of the heat exchangers 18, between inlets and outlets of the distribution manifolds 38, over a duration of time at any sensor location, or any combination thereof. The actuators 258 may include valve actuators, such as valve actuators for the waste gate 214 and the bypass valve 216, pump actuators for the heat exchanger fluid system 229, drive actuators for the positioning system 92, valve actuators for the EGR valves 222 and 224, or any combination thereof.

The sensors 256 monitor the parameters for recordation along with other information, which is collectively used to trigger changes in positions of the heat exchangers 18. The sensors 256 may include physical sensors and/or virtual sensors, which are configured to measure certain parameters based on input data. Accordingly, certain parameters may be measured directly via physical sensors and/or indirectly via virtual sensors. In certain embodiments, the recorded information may include the identification of heat exchangers 18 based in the identifiers 60, the location of the heat exchangers 18, the monitored parameters, service and maintenance data, or any combination thereof, for the heat exchangers 18 at the present time and over the course of the heat exchanger's life. The monitored parameters may include a temperature, a pressure, a flow rate, a leakage, a composition of the fluid, a vibration, a time, reciprocating engine metrics, or any combination thereof. The service and maintenance data may include the number of inspections and repairs, the types of inspections and repairs (e.g., leak repair, crack repair, etc.), the total downtime (e.g., minutes, hours, days) for the inspections and repairs, or any other relevant data pertaining to the performance of the heat exchanger 18.

The monitored parameters noted above may be further characterized as set forth below. At least some or all of the monitored parameters may correspond to the fluids passing through the heat exchangers 18, such as the exhaust gas and the heat exchange fluids (e.g., main engine fluid 150 and auxiliary fluid 152). The measured temperature may include an exhaust gas temperature, a main fluid temperature, and/or an auxiliary fluid temperature, wherein the respective temperatures may include temperatures measured at the inlets and the outlets and changes in temperatures between the inlets and the outlets of the heat exchanger 18. For exhaust gas temperatures, the exhaust gas temperatures may include EGR exhaust gas temperatures, heat recovery (HR) exhaust gas temperatures (e.g., in the exhaust gas waste heat recovery system 106), or any combination thereof. Similarly, the measured pressure may include an exhaust gas pressure, a main fluid pressure, and/or an auxiliary fluid pressure, wherein the respective pressures may include pressures measured at the inlets and the outlets and changes in pressures between the inlets and the outlets (e.g., pressure drops) of the heat exchanger 18. Similarly, the measured flow rate may include an exhaust gas flow rate, a main fluid flow rate, and/or an auxiliary fluid flow rate, wherein the respective flow rates may include flow rates measured at the inlets and the outlets and changes in flow rates between the inlets and the outlets of the heat exchanger 18. Similarly, the measured leakage may include an exhaust gas leakage, a main fluid leakage, and/or an auxiliary fluid leakage, wherein the respective leakages may include leakages measured at the inlets, the outlets, and along flow paths between the inlets and the outlets of the heat exchanger 18. The measured composition of fluid may include a composition of the exhaust gas, a composition of the main engine fluid 150, and a composition of the auxiliary fluid 152. For example, the measured composition of the exhaust gas may include a humidity or water content in the exhaust gas, a particulate or soot content in the exhaust gas, a carbon dioxide (CO₂) content in the exhaust gas, a nitrogen oxide (NOx) content in the exhaust gas, a sulfur oxide (SOx) content in the exhaust gas, or any combination thereof. The measured time may include operating time (e.g., minutes, hours, days) of the reciprocating engine 24 or 26 with and without the EGR system (e.g., EGR circuit 202, 204), operating time of each individual heat exchanger 18 in each respective position, operating time of the EGR system (e.g., EGR circuit 202, 204), absolute time, time since prior swap alert override, and other measures of time affecting the performance of the heat exchanger 18. The prior swap alert override may correspond to a swap alert recommending changes in positions of the heat exchangers 18, but an override is used to continue operating without immediately making the recommended changes. The reciprocating engine metrics may include power output by the reciprocating engine 24 or 26 with and without the EGR system (e.g., EGR circuit 202, 204), total volume of flow through the EGR system (e.g., EGR circuit 202, 204), total number of starts and stops of the reciprocating engines 24 or 26, and/or various other metrics for the reciprocating engine 24 or 26. Each of the foregoing parameters may be used to analyze the performance of the heat exchangers 18 and trigger changes in positions of the heat exchangers 18. Any discussion of monitored parameters, conditions, sensor feedback, and the like, in the present application is intended to cover each of the foregoing aspects.

The controller 254 may include one or processors 260, memory 262, instructions 264 stored on the memory 262 and executable by the processor 260, and communication circuitry 266 configured to communicate with the sensors 256, the actuators 258, the positioning system 92, and various components throughout combustion system 10. In certain embodiments, the controller 254 is configured to communicate with the portable computing device 126, which may be a portable handheld device used by a technician to facilitate inspection and movements of the heat exchangers 18 throughout the combustion system 10. For example, the controller 254 and/or the portable computing device 126 may be configured to receive sensor feedback from the sensors 256, identify changes in monitored parameters, identify when thresholds are crossed for the parameters, and generate outputs to trigger changes in the positions of the heat exchangers 18. For example, the controller 254 and/or the portable computing device 126 may detect threshold reductions in performance in one or more of the heat exchangers 18, and then provide outputs to recommend changes in the position of one or more of the heat exchangers 18. The controller 254 and/or the portable computing device 126 may use local and/or remote computer systems and storage, web-based interfaces, cloud-based interface, apps on smart devices (e.g., smart phones, tablet computers, etc.), or any suitable use interface to enable the changes in heat exchanger 18 positions. In certain embodiment, the controller 254 and/or the portable computing device 126 may implement a cloud-based platform used for asset management of the reciprocating engines 24 and 26, such as myPlant, provided by Innio of Jenbach, Tyrol, Austria.

The positioning system 92 is configured to facilitate movement of the heat exchangers 18 between the heat exchanger assemblies 36, the cleaning system 20, the spare storage 22 for additional or spare heat exchangers 94, 96, and 98, other engines 24, or any combination thereof. The spare storage 22 may include new, unused heat exchangers 18, cleaned heat exchangers 18 from the cleaning system 20, or a combination thereof. In certain embodiments, the spare storage 22 may include only one spare heat exchanger 18; however, in certain embodiments, the spare storage 22 may include a plurality of spare heat exchangers to facilitate movements of the heat exchangers 18 between various positions in the combustion system 10.

The cleaning system 20 may include a plurality of components 268, such as components 270, 272, 274, and 276, configured to facilitate cleaning of each one of the heat exchangers 18 undergoing a cleaning process when taken offline from one of the heat exchanger assemblies 36. The components 270, 272, 274, and 276 may be configured to facilitate a clean-in-place (CIP) procedure, wherein the heat exchangers 18 are internally cleaned with a flushing fluid without disassembly of the heat exchangers 18. For example, the component 270 may include one or more heaters, the component 272 may include one or more filters (e.g., cartridge filters), the component 274 may include one or more fluid tanks, and the component 276 may include one or more cleaning controllers. The heaters 270 may include electric heaters, heat exchangers, or other heating elements. The filters 272 may include one or more filters to remove particulate, such as cartridge filters, centrifugal separators, gravity separators, or any combination thereof. The fluid tanks 274 may include one or more fluid tanks to store water, cleaning solutions, scale removers, detergents, or other substances to facilitate cleaning of the interior fluid passages and external surface of the heat exchangers 18. The controllers 276 may include a processor-based controller configured to control the temperature via the heaters 270, a flow through the filters 272, a fluid supply by the fluid tanks 274, and various cleaning procedures.

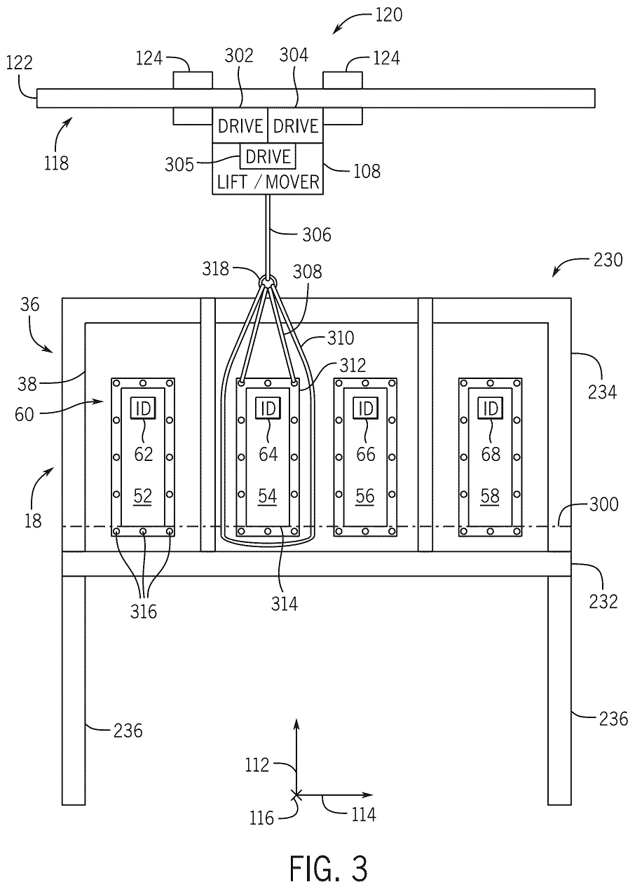

FIG. 3 is a front view of an embodiment of the heat exchange system 12 having one of the heat exchanger assemblies 36 disposed in the support system 230 and coupled to the positioning system 92 for moving one of the heat exchangers 18 between different positions in the combustion system 10. As illustrated, the support system 230 includes a plurality of the legs 236 (e.g., four legs) extending downwardly from the horizontal support 232, while the vertical support 234 extends upwardly from the horizontal support 232. The horizontal support 232 is configured to support the plurality of heat exchangers 18, while the vertical support 234 is configured to support the distribution manifold 38. The support system 230 may include one or more horizontal support layers 300 disposed along the horizontal support 232 below the heat exchangers 18. For example, the horizontal support layers 300 may include one or more resilient pads (e.g., elastomeric or rubber pads) or low friction pads (e.g., nylon or Teflon pads) to facilitate movement of the heat exchangers 18 when disconnecting from the distribution manifold 38 and lifting and moving away via the positioning system 92. The positioning system 92 includes the rail assemblies 118 and 120, which are oriented along the horizontal axes 114 and 116 respectively. The positioning system 92 also includes the lift/mover 108 coupled to one or both of the rail assemblies 118 and 120.

In the illustrated embodiment, the positioning system 92 includes a plurality of drives, such as drives 302, 304, and 305, as part of the lift/mover 108. For example, the drive 302 may be configured to move the lift/mover 108 along the rail 118. The drive 304 may be configured to move the lift/mover 108 along the rail assembly 120. The drive 305 may be configured to raise and lower a harness 306 of the lift/mover 108, wherein the harness 306 is disposed about the heat exchanger 18 at one or more positions. For example, the harness 306 may include a plurality of harness portions 308 and 310 configured to couple to the heat exchanger 18 in different positions. For example, the harness portion 308 may be configured to couple to a flange 312 of the heat exchanger 18, while the harness portion 310 (e.g., a harness loop, expandable/contractable strap, etc.) may be configured to wrap around a body 314 of the heat exchanger 18.

As illustrated in FIG. 3, each of the heat exchangers 18 is coupled to the distribution manifold 38 via the flange 312. For example, the flange 312 may be removably coupled to the distribution manifold 38 via a plurality of fasteners 316, such as threaded fasteners (e.g., threaded bolts, threaded nuts, etc.), fastener receptacles, clamps, latches, hooks, or any combination thereof. In certain embodiments, the flange 312 includes fastener receptacles configured to receive threaded fasteners (e.g., threaded bolts) into threaded holes in the distribution manifold 38. In other embodiments, the flange 312 may include threaded fasteners (e.g., threaded bolts or studs), which extend through fastener receptacles in the distribution manifold 38 and couple with threaded nuts.

In either case, the harness portion 308 may be configured to couple to the fasteners 316 (e.g., receptacles, posts, bolts, etc.) to provide support for the heat exchangers 18 at the flange 312 that couples with the distribution manifold 38. The harness portion 310 may be disposed further away from the flange 312, thereby providing additional support of the heat exchanger 18 along the body 314. In certain embodiments, the harness portions 308 and 310 may be coupled to a load bar or support 318, such as an I-beam, rectangular beam, cylindrical beam, or any combination thereof. The load bar or support 318 is configured to position the harness portions 308 and 310 at different offset locations along the heat exchanger 18, thereby helping to distribute the load when using the lift/mover 108 (e.g., via drives 302, 304, and 305) to move the heat exchanger 18. The positioning system 92 is configured to use the lift/mover 108 to raise and lower the heat exchanger 18 along the vertical axis 112 via the drive 305 and harness 306, while using the rail assemblies 118 and 120 and respective drives 302 and 304 to move the heat exchanger 18 along the horizontal axes 114 and 116. The positioning system 92 is then able to move the heat exchangers 18 between the different heat exchanger assemblies 36, the cleaning system 20, the spare storage 22, and so forth.

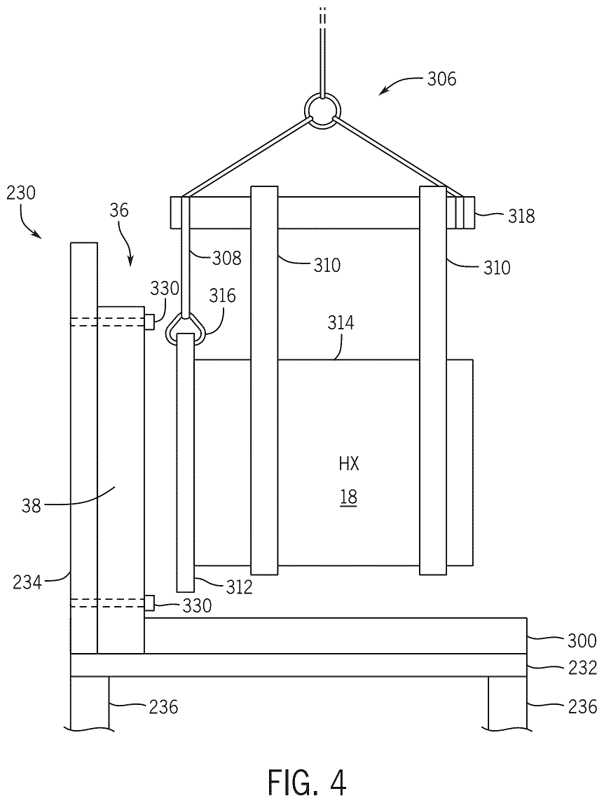

FIG. 4 is a side view of an embodiment of the positioning system 92 and the heat exchanger assembly 36 of FIG. 3, further illustrating details of the support system 230 and the positioning system 92. As illustrated, the support system 230 includes the legs 236 (e.g., four legs) extending downwardly from the horizontal support 232, and the vertical support 234 extending upwardly from the horizontal support 232 along a backside of the distribution manifold 38. The support system 230 also includes the horizontal support layers 300 disposed along the horizontal support 232. Again, the horizontal support layers 300 may include a resilient layer (e.g., rubber or elastomeric layer) configured to provide some cushion for the heat exchangers 18 and/or the horizontal support layers 300 may include one or more low friction layers (e.g., nylon or Teflon layers) to facilitate sliding of the heat exchangers 18 along the horizontal support 232. The distribution manifold 38 may be secured to the vertical support 234 via a plurality of fasteners 330, such as a plurality of threaded bolts extending through the distribution manifold 38 into the vertical support 234.

The positioning system 92 includes the harness 306 extending downwardly from the lift/mover 108. As illustrated, the harness 306 includes the harness portions 308 and 310 coupled to the load bar or support 318. For example, the harness 306 has the harness portion 308 coupled to the load bar or support 318 and the fasteners 316 of the flange 312. In the illustrated embodiment, the harness 306 has a plurality of the harness portions 310 coupled to the load bar or support 318 and extending around different portions of the body 314 of the heat exchanger 18. In particular, the harness portions 308 and 310 are offset from one another at different positions along the load bar or support 318, such that the load of the heat exchanger 18 is more uniformly distributed along the load bar or support 318. In the illustrated embodiment, each of the harness portions 310 may be wrapped around an outer perimeter of the body 314. In some embodiments, the harness 306 may be coupled to the heat exchanger 18 via integrated hooks, loops, or other fastening connections at locations along the heat exchanger 18. Once the flange 312 is disconnected from the distribution manifold 38, the positioning system 92 may be configured to move the heat exchanger 18 horizontally along one or both of the horizontal axes 114 and 116 via the rail assemblies 118 and 120 and drives 302 and 304, and move the heat exchanger 18 vertically along the vertical axis 112 via the drive 305.

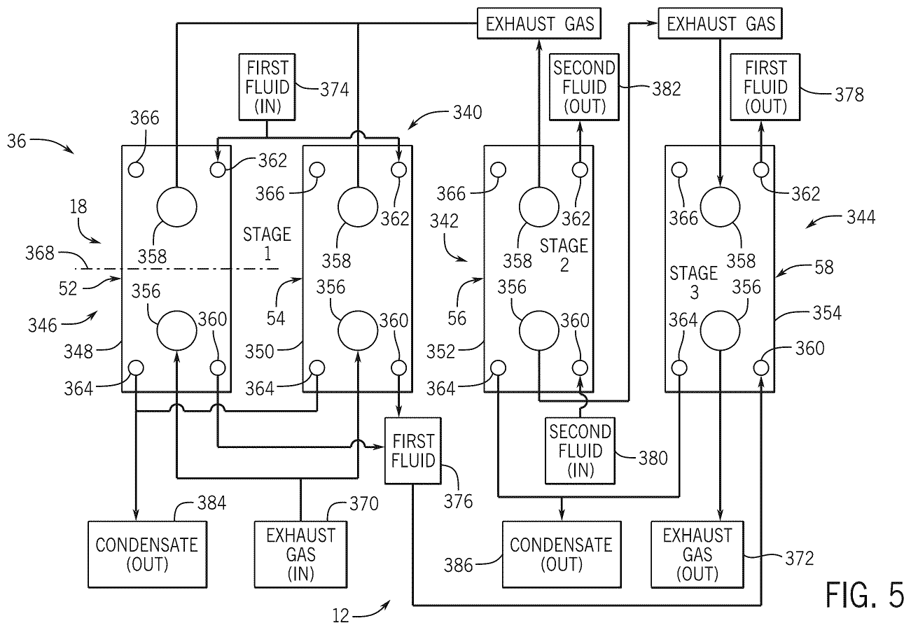

FIG. 5 is schematic view of an embodiment of the heat exchange system 12 of FIGS. 1 and 2, further illustrating details of the heat exchangers 18 in the heat exchanger assembly 36. In the illustrated embodiment, the heat exchanger assembly 36 is arranged with the heat exchangers 18 both in a series arrangement and a parallel arrangement. In particular, the illustrated embodiment of the heat exchanger assembly 36 has the heat exchangers 52 and 54 disposed in a first heat exchange stage 340, the heat exchanger 56 disposed in a second heat exchange stage 342, and the heat exchanger 58 disposed in a third heat exchange stage 344. The heat exchangers 52 and 54 in the first heat exchange stage 340 are disposed in a parallel arrangement relative to one another. As illustrated in FIG. 5, each of the heat exchangers 18 includes a common mounting interface 346, such as mounting interfaces 348, 350, 352, 354 on the respective heat exchangers 52, 54, 56, and 58. Each of the mounting interfaces 346 has common connections (e.g., common mechanical connections and common fluid connections) to facilitate movement of the heat exchangers 18 between various locations throughout the combustion system 10.

As illustrated in FIG. 5, each of the heat exchangers 18 includes exhaust ports 356 and 358, fluid ports 360 and 362, and condensate ports 364 and 366 in a common arrangement. Inside of the heat exchanger 18, the exhaust ports 356 and 358 are fluidly coupled together via one or more exhaust passages, the fluid ports 360 and 362 are fluidly coupled together via one or more fluid passages, and the condensate ports 364 and 366 are fluidly coupled together via one or more condensate passages. The exhaust ports 356 and 358, the fluid ports 360 and 362, and the condensate ports 364 and 366 have common relative positions on the mounting interface 346 on each of the heat exchangers 18, such that the heat exchangers 18 can be mounted at any of the locations throughout the combustion system 10. The exhaust ports 356 and 358 may have a common size (e.g., common geometry) relative to one another, the fluid ports 360 and 362 may have a common size relative to one another, and the condensate ports 364 and 366 may have a common size relative to one another. In the illustrated embodiment, the exhaust ports 356 and 58 are larger than both the fluid ports 360 and 362 and the condensate ports 364 and 366. The fluid ports 360 and 362 also may be larger than the condensate ports 364 and 366. In certain embodiments, the exhaust ports 356 and 358 may be arranged symmetric about a plane or axis 368, the fluid ports 360 and 362 may be disposed symmetric about the plane or axis 368, and the condensate ports 364 and 366 may disposed symmetric about the plane or axis 368. The heat exchanger 18 may be reversed 180 degrees about the axis 368, while still facilitating connections between the exhaust ports 356 and 358, the fluid ports 360 and 362, and the condensate ports 364 and 366.

The flows through the heat exchangers 18 may be the same or different in various stages and positions. In certain embodiments, the exhaust flow through the exhaust passage between the exhaust ports 356 and 358 may be opposite to the fluid flow through the fluid passage between the fluid ports 360 and 362. The flows of exhaust gas and fluid may be opposite or counter flow relative to one another. However, in certain embodiments, the exhaust flow and the fluid flow through the heat exchanger 18 may be in the same flow direction as one another.

The mounting interface 346 may represent a flat surface or planar surface having the exhaust ports 356 and 358, the fluid ports 360 and 362, and the condensate ports 364 and 366. Each of the illustrated ports may have a seal groove supporting a seal ring, such as an elastomeric seal ring, a metal seal ring, or any combination thereof. Although each of the heat exchangers 18 has the common mounting interface 346 with the associated ports, the flows through each of the heat exchangers 18 may be the same or different from one another.

In the illustrated embodiment, the heat exchangers 52 and 54 in the first heat exchange 340 are arranged to receive parallel flows through the respective passages. For example, the heat exchangers 52 and 54 receive an input flow of exhaust gas from an exhaust gas (in) 370 into the exhaust ports 356, the exhaust gas flows through the internal exhaust passages to the exhaust ports 358, and then exhaust gas flows out through the exhaust ports 358 in parallel to one another to the exhaust port 358 in the heat exchanger 56 in the second heat exchange stage 342. The exhaust gas then flows through the internal exhaust passage within the heat exchanger 56 to the exhaust port 356, and then the exhaust gas exits through the exhaust port 356 and flows into the exhaust port 358 in the heat exchanger 58 in the third heat exchange stage 344. The exhaust gas then flows through the internal exhaust passage in the heat exchanger 58 to the exhaust port 356, and then the exhaust gas flows out from the exhaust port 356 to an exhaust gas (out) 372. The exhaust gas flows through the heat exchangers 18 first in parallel through the heat exchangers 52 and 54 in the first heat exchange stage 340, followed by a series flow through the heat exchangers 56 and 58 in the second and third heat exchange stages 342 and 344. In the illustrated embodiment, the exhaust gas (in) 370 may correspond to the exhaust gas flow discharged from the exhaust manifold 182 of the reciprocating engine 26 of FIG. 2, whereas the exhaust gas (out) 372 may correspond to the exhaust gas discharged from the manifold 38 and directed to the EGR valve 222 or 224 as illustrated in FIG. 2. For example, in certain embodiments, the exhaust gas (in) 370 may include an exhaust gas input port in the distribution manifold 38, and the exhaust gas (out) 372 may include an exhaust gas (out) port in the distribution manifold 38. The distribution manifold 38 may include a matching mounting interface to couple with each of the mounting interfaces 346 of the heat exchangers 18.

In the first heat exchange stage 340, the heat exchangers 52 and 54 are configured to receive a first fluid flow from a first fluid (in) 374 (e.g., port in the distribution manifold 38), which directs a flow of the first fluid into the fluid ports 362 in the heat exchangers 52 and 54. The first fluid then flows through the heat exchangers 52 and 54, and then the first fluid exits through the fluid ports 360 into the distribution manifold 38 as indicated by first fluid 376 (shown as a box). The first fluid is then routed by the distribution manifold 38 into the heat exchanger 58 in the third heat exchange stage 344 via the fluid port 360. The first fluid then flows through an internal fluid passage in the heat exchanger 58 from the fluid port 360 to the fluid port 362, wherein the fluid port 362 then discharges the first fluid as indicated by a first fluid (out) 378. The first fluid (out) 378 may correspond to a first fluid out port disposed in the distribution manifold 38. In the illustrated embodiment, a second fluid also may be used for heat transfer in addition to the first fluid 376 passing through the heat exchangers 52, 54, and 58.

For example, the heat exchanger assembly 36 may include a second fluid (in) 380 (e.g., port in the distribution manifold 38), which directs a flow of a second fluid into the fluid port 360 in the heat exchanger 56, wherein the second fluid flows through an internal fluid passage from the fluid port 360 to the fluid port 362, and then exits from the fluid port 362 into a second fluid (out) 382. The second fluid (out) 382 may correspond to a second fluid out port disposed in the distribution manifold 38.

As noted above, each heat exchanger 18 may include condensate ports 364 and 366. However, one of the condensate ports may be inactive depending on the orientation of the heat exchanger 18. For example, the upper most condensate port 366 may be inactive in each of the illustrated heat exchangers 18, while the lower condensate port 364 may be active in at least one or more of the heat exchangers 18. For example, the condensate ports 364 of the heat exchangers 52 and 54 in the first heat exchange stage 340 may discharge a condensate to a condensate (out) 384, which may include a condensate out port disposed in the distribution manifold 38. Similarly, the condensate ports 364 in the heat exchangers 56 and 58 may discharge a condensate flow to a condensate (out) 386, which may be the same or different than the condensate (out) 384. The condensate (out) 386 may correspond to a condensate (out) port disposed in the distribution manifold 38.

In the illustrated embodiment, the exhaust flow and the fluid flow through each of the heat exchangers 18 is arranged to provide counter flows, which may facilitate heat transfer in each respective heat exchanger 18. However, in certain embodiments, the exhaust flow and the fluid flow may be parallel or in the same direction relative to one another. In some embodiments, the first heat exchange stage 340 may include only one of the heat exchangers 52 or 54, or the first heat exchange stage 340 may include additional heat exchangers 18. Similarly, the heat exchange stages 342 and 344 are illustrated with only one respective heat exchangers 56 and 58; however, each of the heat exchange stages 342 and 344 may include any number of heat exchangers 18, such as 2, 3, 4, or more heat exchangers 18. Again, the disclosed embodiments enable shuffling of the heat exchangers 18 (e.g., 52, 54, 56, and 58) between the different positions, such as between the different stages 340, 342, and 344.

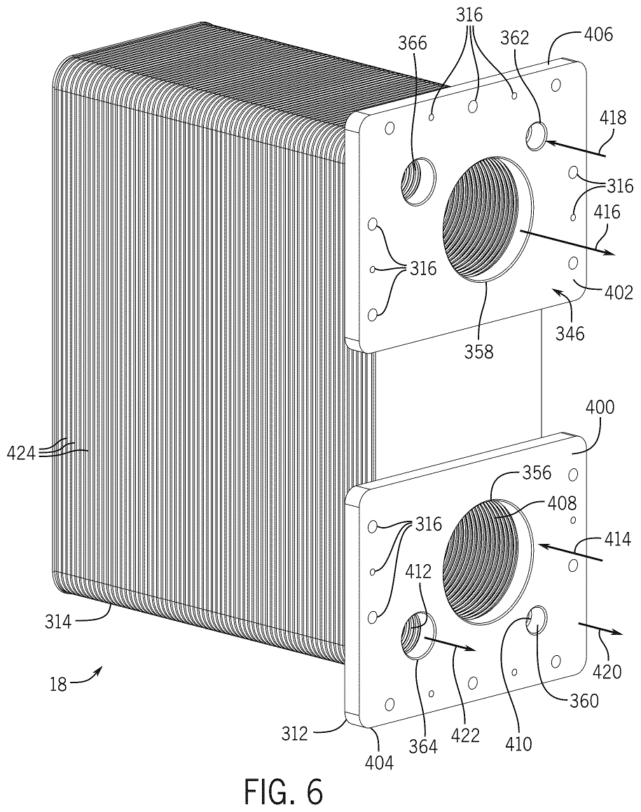

FIG. 6 is a perspective view of an embodiment of the heat exchanger 18 of FIGS. 1-5, further illustrating details of the flange 312 having the mounting interface 346 and the body 314. As illustrated, the mounting interface 346 may include a first mounting interface portion 400 and a second mounting interface portion 402, which are disposed on respective first and second flange portions 404 and 406 of the flange 312. The flange portion 404 having the mounting interface 400 includes the exhaust port 356, the fluid port 360 and the condensate port 364. The flange portion 406 having the mounting interface portion 402 includes the exhaust port 358, the fluid port 362, and the condensate port 366. The exhaust ports 356 and 358 are fluidly coupled together via an exhaust passage 408 extending internally through the body 314 of the heat exchanger 18. Similarly, the fluid passages 360 and 362 are fluidly coupled together with a fluid passage 410 extending internally through the body 314 of the heat exchanger 18. Finally, the condensate passages 364 and 366 may be fluidly coupled together via a condensate passage 412 extending internally through the body 314 of the heat exchanger 18. The fluid passage 410 is sealed relative to the exhaust passage 408, and all of the ports are sealed relative to one another along the mounting interface 346.

In certain embodiments, the exhaust and fluid flows are counter flow relative to one another. For example, as illustrated, the heat exchanger 18 may receive an exhaust flow into the exhaust port 356 as indicated by arrow 414 and discharge an exhaust flow from the exhaust port 358 as indicated by arrow 416. The heat exchanger 18 may receive a fluid flow into the fluid port 362 as indicated by arrow 418 and discharge the fluid flow from the fluid port 360 and indicated by arrow 420. The heat exchanger 18 also may plug or cover one of the condensate ports, such as the upper condensate port 366. The heat exchanger 18 may discharge a condensate flow from the condensate port 364 as indicated by arrow 422. In this embodiment, the exhaust flow is counter to the fluid flow; however, the heat exchanger 18 may be configured with the same direction of flows at the exhaust port 356 and the fluid port 360, and also the same direction of flows at the exhaust port 358 and the fluid port 362.

In the illustrated embodiment, the body 314 includes a plurality of plates 424 stacked one over the other parallel with the mounting interface 346, thereby defining flow passages between the plates to facilitate heat transfer between the exhaust gas and the fluid flow through the heat exchanger 18. For example, the plates 424 may be stacked and brazed together to define the various flow paths through the exchanger 18. In certain embodiments, the plates 424 may include 10 to 500 plates, 15 to 400 plates, or 20 to 280 plates. The plate configuration (e.g., the number, size, construction, and arrangement) of the plates 424 may vary for different applications, engines 24 and 26, desired cooling desired pressure drops (e.g., exhaust gas pressure drop), and so forth. However, once the plate configuration is selected for the system, the same plate configuration (i.e., a common plate configuration) may be used for all of the heat exchangers 18 being moved around the system. The heat exchangers 18 also may have other design configurations. In some embodiments, the body 314 may have a different construction of a gas-liquid heat exchanger with gas passages isolated from liquid passages. However, each heat exchanger 18 may have generally the same mechanical connections (e.g., fasteners 316) and fluid connections (e.g., ports 356, 358, 360, 362, 364, and 366) to facilitate movement of the heat exchangers 18 between the different positions in the combustion system 10.

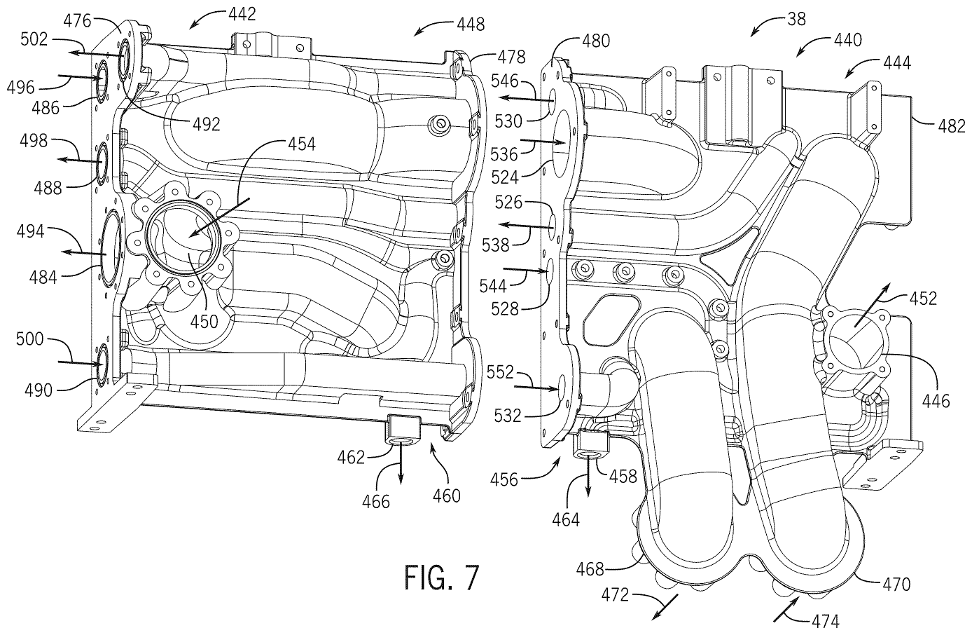

FIG. 7 is an exploded rear perspective view of an embodiment of the distribution manifold 38 of FIGS. 1-4, further illustrating details of the ports and fluid connections to facilitate heat transfer between an exhaust gas and multiple fluids. In the illustrated embodiment, the distribution manifold 38 has multiple manifolds or manifold portions 440 and 442, which are configured to removably couple together to define the entire distribution manifold 38. However, in certain embodiments, the distribution manifold 38 may be a continuous one-piece distribution manifold (e.g., single cast manifold), the distribution manifold 38 may include additional manifold portions to removably couple together to form the entire distribution manifold, or all or part of the distribution manifold 38 may instead be formed with a plurality of conduits or tubing.

In the illustrated embodiment, a rear surface 444 of the manifold portion 440 includes an exhaust port 446, while a rear surface 448 of the manifold portion 442 includes an exhaust port 450. The exhaust port 446 may correspond to an exhaust discharge port configured to couple to the intake manifold 184 of the reciprocating engine 26 through an EGR valve (e.g., 222, 224). The exhaust port 450 may include an exhaust input port configured to couple to the exhaust manifold 182 of the reciprocating engine 26. For example, the exhaust ports 446 and 450 may connect to exhaust tubing, which then leads to the respective connections in the combustion system 10. Arrow 452 illustrates an exhaust discharge flow from exhaust port 446, while arrow 454 depicts an exhaust intake flow into the exhaust port 450.

A bottom surface 456 of the manifold portion 440 includes a condensate port 458, while a bottom surface 460 of the manifold portion 442 includes a condensate port 462. The condensate ports 458 and 462 are configured to discharge a condensate from the manifold portions 440 and 442 as illustrated by arrows 464 and 466, respectively. The manifold portion 440 also may include ports 468 and 470 configured to couple with a liquid gas separator to separate liquid and gas outside of the distribution manifold 38. For example, the port 468 may correspond to an inlet port from the separator as indicated by arrow 472, while the port 470 may correspond to a discharge port out to the separator as indicated by arrow 474. The separator may include a centrifugal separator, a gravity separator, or any other suitable liquid gas separator.

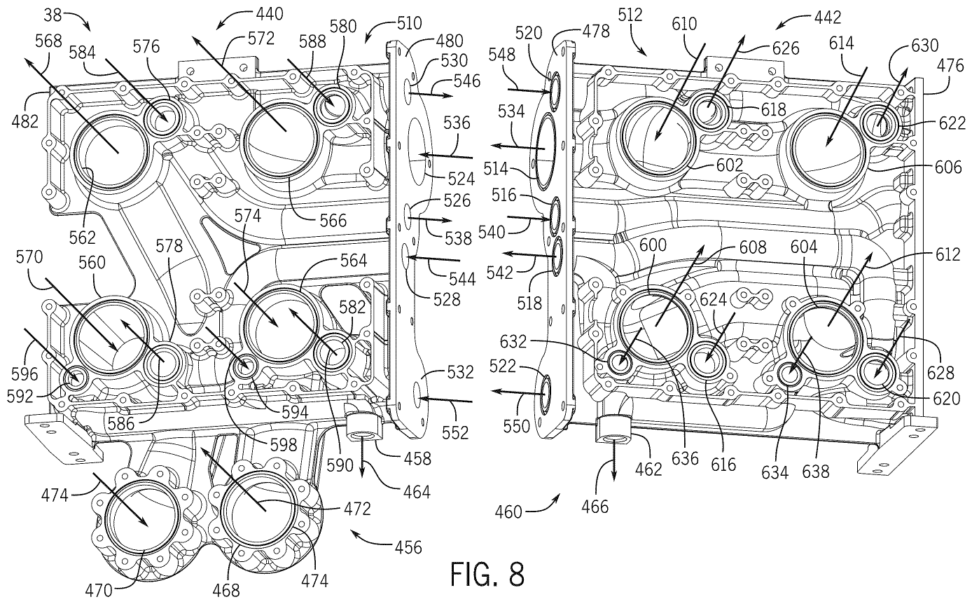

The manifold portion 442 includes side surfaces 476 and 478 disposed on opposite sides of the manifold portion 442. The manifold portion 440 also includes side surfaces 480 and 482 disposed on opposite sides of the manifold portion 440. The side surfaces 478 and 480 of the manifold portions 442 and 440 are configured to removably coupled together to define a mechanical and fluid interface as discussed in further detail below with reference to FIG. 8. The side surface 476 of the manifold portion 442 may be configured to mount onto another manifold or fluid connections, such that various flows can enter and discharge from the distribution manifold 38.

In the illustrated embodiment, the side surface 476 of the manifold portion 442 includes an exhaust port 484, a fluid port 486, a fluid port 488, a fluid port 490, and a fluid port 492. In certain embodiments, the exhaust port 484 is configured to discharge exhaust gas from the distribution manifold 38 to an exhaust stack or other downstream location as indicated by arrow 494. The fluid port 486 may be configured to receive an intake of a first fluid as indicated by arrow 496, while the fluid port 488 may be configured to discharge a flow of the first fluid as indicated by arrow 498. Finally, the fluid port 490 may be configured to receive an intake flow of a second fluid as indicated by arrow 500, while the fluid port 492 may be configured to discharge a flow of the second fluid as indicated by arrow 502. The exhaust port 484 and the various fluid ports 486, 488, 490, and 492 are configured to connect with internal passages through the distribution manifold 38, which also connect with the heat exchangers 18 via corresponding ports as discussed in further detail below with reference to FIG. 8.

FIG. 8 is an exploded front perspective view of the distribution manifold 38 of FIG. 7, illustrating the manifold portions 440 and 442 exploded relative to one another and illustrating front surfaces 510 and 512 of the respective manifold portions 440 and 442. As illustrated in FIGS. 7 and 8, the manifold portions 440 and 442 are configured to removably couple together at the side surfaces 478 and 480 and create a plurality of exhaust and fluid connections along the connected side surface 478 and 480. The side surface 478 includes an exhaust port 514, a fluid port 516, a fluid port 518, a fluid port 520, and a fluid port 522. Similarly, the side surface 480 includes an exhaust port 524, a fluid port 526, a fluid port 528, a fluid port 530, and a fluid port 532. When the side surfaces 478 and 480 are removably coupled together via a plurality of fasteners (e.g., threaded bolts, nuts, etc.), the exhaust ports 516 and 524 are fluidly coupled together, the fluid ports 516 and 526 are fluidly coupled together, the fluid ports 518 and 528 are fluidly coupled together, the fluid ports 520 and 530 are fluidly coupled together, and the fluid ports 522 and 532 are fluidly coupled together.

In the illustrated embodiment, the exhaust ports 514 and 524 direct a flow of exhaust gas from the manifold portion 442 to the manifold portion 440 as illustrated by arrows 534 and 536. Similarly, the fluid ports 516 and 526 are fluidly coupled together to direct a first fluid flow from the manifold portion 440 to the manifold portion 442 as indicated by arrows 538 and 540. The fluid ports 518 and 528 are fluidly coupled together to direct the first fluid flow from the manifold portion 442 to the manifold portion 440 as indicated by arrows 542 and 544. The fluid ports 520 and 530 are fluidly coupled together to direct a second fluid flow from the manifold portion 440 to the manifold portion 442 as indicated by arrows 546 and 548. Finally, the fluid ports 522 and 532 are fluidly coupled together to direct the second fluid flow from the manifold portion 442 to the manifold portion 440 as indicated by arrows 550 and 552.

As further illustrated in FIG. 8, the front surface 510 of the manifold portion 440 includes exhaust ports 560, 562, 564, and 566 configured to circulate an exhaust gas flow through heat exchangers 18. For example, one of the heat exchangers 18 may receive an exhaust gas flow from the manifold portion 440 at the exhaust port 562 as illustrated by arrow 568, and discharge the exhaust gas flow (after cooling) back to the manifold portion 440 at the exhaust port 560 as illustrated by arrow 570. Similarly, one of the heat exchangers 18 may receive an exhaust gas flow from the manifold portion 440 at the exhaust port 566 as indicated by arrow 572, and discharge the exhaust gas flow (after cooling) back into the manifold portion 440 at the exhaust port 564 as illustrated by arrow 574. In the illustrated embodiment, the manifold portion 440 has the exhaust ports 560, 562, 564, and 566 arranged to direct the exhaust gas flow through the heat exchanger 18 in the direction of gravity to help promote the separation of a condensate from the exhaust gas flow.

The manifold portion 440 also may include fluid ports 576, 578, 580, and 582 configured to circulate one or more fluids through the manifold portion 440 to exchange heat with the exhaust gas flow. For example, one of the heat exchangers 18 may discharge a fluid flow into the manifold portion 440 at the fluid port 576 as indicated by arrow 584, and the heat exchanger 18 may receive the fluid flow from the manifold portion 440 at the fluid port 578 as indicated by arrow 586. Similarly, another one of the heat exchangers 18 may discharge a fluid flow into the manifold portion 440 at the fluid port 580 as indicated by arrow 588, and the heat exchanger 18 may receive the fluid flow from the manifold portion 440 at fluid port 582 and indicated by arrow 590.

In the illustrated embodiment, the manifold portion 440 may correspond to the first heat exchange stage 340 as illustrated and described above with reference to FIG. 5. The heat exchangers 52 and 54 may be coupled to the manifold portion 440, such that the exhaust gas (in) 370 enters the exhaust ports 560 and 564 in parallel, and discharges from the exhaust ports 562 and 566 in parallel. The heat exchangers 52 and 54 may receive the first fluid flow from the fluid ports 578 and 582, and discharge the first fluid flow into the fluid ports 576 and 580. Similar to the embodiment of FIG. 5, the same first fluid may be used for both of the heat exchangers 52 and 54 in the manifold portion 440. The manifold portion 440 may include condensate ports 592 and 594, which are fluidly coupled to the condensate port 458. The heat exchangers 52 and 54 may discharge condensate into the condensate ports 592 and 594 as illustrated by arrows 596 and 598. The heat exchangers 52 and 54 also may be slightly angled or tilted (e.g., 1 to 5 degrees or more) from a vertical orientation, thereby helping to promote draining of the condensate out of the heat exchangers 52 and 54 and the manifold portion 440. The condensate then discharges through the condensate port 458 as illustrated by arrow 464. In the illustrated embodiment, as described above with reference to FIG. 5, the exhaust flow and the first fluid flow in the manifold portion 440 are arranged to provide counter flows of the exhaust gas and the first fluid. However, certain embodiments of the manifold portion 440 may direct the exhaust and first fluid flows in the same direction as one another.

The manifold portion 442 includes a similar arrangement of ports on the front surface 512. As illustrated, the front surface 512 includes exhaust ports 600, 602, 604, and 606. The exhaust ports 600 and 602 may be configured to couple to one heat exchanger 18 such as the heat exchanger 56, while the exhaust ports 604 and 606 may be configured to be coupled to another heat exchanger 18 such as the heat exchanger 58. In operation, the exhaust port 600 may discharge an exhaust flow into the heat exchanger 56 as indicated by arrow 608, while the exhaust port 602 may receive the exhaust flow back from the heat exchanger 56 as indicated by arrow 610. Similarly, the exhaust port 604 may discharge an exhaust flow into the heat exchanger 58 as indicated by arrow 612, while the exhaust port 606 may receive the exhaust gas back from the heat exchanger 58 as indicated by arrow 614. In the illustrated embodiment, the manifold portion 442 has the exhaust ports 600, 602, 604, and 606 arranged to direct the exhaust gas flow through the heat exchanger 18 in a direction opposite from gravity. However, in some embodiments, the manifold portion 442 has the exhaust ports 600, 602, 604, and 606 arranged to direct the exhaust gas flow through the heat exchanger 18 in the direction of gravity to help promote the separation of a condensate from the exhaust gas flow.

The front surface 512 of the manifold portion 442 also includes fluid ports 616, 618, 620, and 622. The fluid port 616 may receive a fluid flow from a heat exchanger 56 as indicated by arrow 624, while the fluid port 618 may discharge the fluid flow into the heat exchanger 56 as indicated by arrow 626. In certain embodiments, the fluid flow passing through the fluid ports 616 and 618 may correspond to the second fluid 380 as discussed above with reference to FIG. 5. The fluid port 620 may receive a fluid flow from the heat exchanger 58 as indicated by arrow 628, while the fluid port 622 may supply the fluid flow to the heat exchanger 58 as indicated by arrow 630. As discussed above with reference to FIG. 5, the fluid flow passing through the fluid ports 620 and 622 may correspond to the first fluid 376 downstream from the first heat exchange stage 340 having the heat exchangers 52 and 54 coupled to the manifold portion 440.

The front surface 512 of the manifold portion 442 may include condensate ports 632 and 634, which are fluidly coupled to the condensate port 462. The condensate ports 632 and 634 may receive condensate flows from the heat exchangers 56 and 58 as indicated by arrows 636 and 638. The condensate flow then passes through the condensate port 462 and exits as indicated by arrow 466. In certain embodiments, the heat exchangers 56 and 58 may be slightly angled or tilted (e.g., 1 to 5 degrees or more) from a vertical orientation, thereby helping to promote draining of the condensate out of the heat exchangers 56 and 58 and the manifold portion 442.

In certain embodiments, the manifold portions 440 and 442 as illustrated in FIGS. 7 and 8 represent the manifold 38 having the flow arrangement as depicted in FIG. 5. The various exhaust ports, fluid ports, and condensate ports may be connected in the manner discussed in detail above with reference to FIG. 5. The manifold portions 440 and 442 may include one or more internal exhaust flow passages, internal first fluid passages, internal second fluid passages, and internal condensate fluid passages between the various ports to facilitate incoming flows, outgoing flows, and flows between the distribution manifold 38 and the heat exchangers 18. Again, in the illustrated embodiment, the manifold portion 440 may represent the first heat exchanger stage 340 having multiple heat exchangers 52 and 54 arranged in parallel upstream from the second heat exchange stage 342 and the third heat exchange stage 344 disposed in the manifold portion 442. In other embodiments, the distribution manifold 38 may include any number and configuration of parallel fluid flows, series fluid flows, or a combination thereof, of the exhaust flows, first fluid flows, second fluid flows, etc.

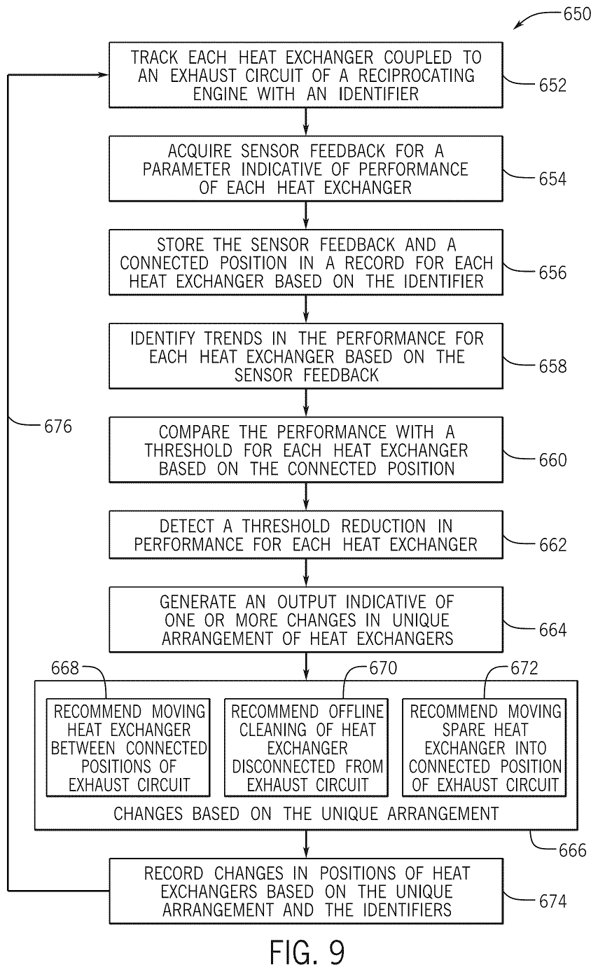

FIG. 9 is a flow chart of an embodiment of a process 650 for shuffling heat exchangers 18 between various positions within a combustion system 10, thereby increasing performance of the plurality of heat exchangers 18 in the combustion system 10. The process 650 also facilitates extending the useful life of the heat exchangers 18 by moving the heat exchangers 18 to various positions as the performance levels decrease for each heat exchanger 18, such that positions with lower performance demands can still use the heat exchangers 18 prior to a cleaning cycle and/or removal from service. In the illustrated embodiment, the process 650 may include tracking each heat exchanger 18 coupled to an exhaust circuit 28 of the reciprocating engine 26 using an identifier 60 as indicated by block 652. For example, as discussed above, the identifier 60 may include a machine-readable identifier, a human-readable identifier, or any combination thereof.

The process 650 then proceeds to acquire sensor feedback for a parameter indicative of a performance of each heat exchanger 18, as indicated by block 654. For example, the sensor feedback may be acquired from one or more sensors 256 distributed throughout the combustion system 10 as illustrated in FIG. 2. The sensor feedback may include any of the sensor feedback, monitored parameters, or conditions discussed throughout the present application, including but not limited to, a temperature, a pressure, a flow rate, a leakage, a composition of the fluid, a vibration, a time, reciprocating engine metrics, or any combination thereof. Additionally, the parameter may include changes in measurements of the parameters between an inlet and an outlet of each heat exchanger 18, thereby indicating changes in internal characteristics within the particular heat exchanger 18. The changes may correspond to changes in the parameters of the exhaust gas, changes in parameters of the heat exchange fluid 142, or a combination thereof. The process 650 then may proceed to store the sensor feedback and a connected position of the particular heat exchanger 18 in a computer record for each heat exchanger 18 based on the identifier 60, as indicated by block 656. For example, for each heat exchanger, the controller 254 and/or the portable computing device 126 may store the sensor feedback and a connected position in the respective memory 262 and 130. For example, for each individual heat exchanger 18, the data stored in the computer record may include the identification corresponding to the identifier 60, the current and past connected positions, the current and past sensor feedback, the current and past performance levels, and the current and past performance thresholds, such that the stored data may include the entire history of operation of the particular heat exchanger 18.

The process 650 may then proceed to identify trends in the performance for each heat exchanger 18 based on the sensor feedback as indicated by block 658. For example, the controller 254 and/or the portable computing device 126 may analyze the sensor feedback, historical data, computer models, user input, and other information to determine whether the performance of the heat exchanger 18 is trending toward one or more thresholds, which may trigger changes in the heat exchanger positions, cleaning, or other control actions. The process 650 may then proceed to compare the performance with a threshold for each heat exchanger 18 based on the connected position as indicated by block 660. The threshold may be specific to a particular connected position, such as a first heat exchanger stage 340, a second heat exchange stage 342, and a third heat exchange stage 344. At each of these stages, the performance levels suitable for a heat exchanger 18 may be different, for example, the performance level threshold for the first heat exchange stage 340 may be greater than the corresponding performance levels for the second and third heat exchange stages 342 and 344. Similarly, the performance level threshold for the heat exchanger 18 at the second heat exchange stage 342 may be greater than the corresponding performance level threshold at the third heat exchange stage 344. The thresholds for performance at the different locations also may depend on the particular application, such as heat exchange in the EGR circuit 202 upstream of the turbocharger 194, the EGR circuit 204 downstream from the turbocharger 194, the heat recovery system 106 coupled to the exhaust section 194, other engines 24, or any combination thereof.

The process 650 may then detect a threshold reduction in performance for each heat exchanger 18 as indicated by block 662. For example, at each connected position of heat exchangers 18, the controller 254 and/or the portable computing device 126 may evaluate whether the performance level has dropped below the performance threshold level for that particular location. The process 650 may then generate an output indicative of one or more changes in the unique arrangement of heat exchangers 18 as indicated by block 664. The recommended changes may include only one change, two changes, three changes, or any number of positional changes or shuffling of the heat exchangers 18. For example, the process 650 may recommend various movements of positional changes of the heat exchangers 18 based on the unique arrangement as indicated by block 666. The illustrated changes 666 may include recommending moving the heat exchanger 18 between connected positions of one or more exhaust circuits as indicated by block 668, recommending offline cleaning of the heat exchanger 18 when disconnected from the exhaust circuit as indicated by block 670, and/or recommending moving a spare heat exchanger into a connected position of the exhaust circuit as indicated by block 672. For example, the recommended movements of block 668 may include recommended movements of the heat exchangers 18 between connected positions within one of the heat exchanger assemblies 36, between different heat exchanger assemblies 36, within one of the EGR circuits 202 or 204, between the different EGR circuits 202 and 204, between one of the EGR circuits 202 and 204 and the heat recovery system 106, between positions within the heat recovery system 106, between different engines such as the reciprocating engine 26 and other engines 24, or any combination thereof. The recommended cleaning of block 670 may include recommended movements of any connected heat exchanger 18 for offline cleaning at the cleaning system 20. The recommended movements of block 672 may include recommended movements of one or more of the heat exchangers 94, 96, or 98 from the spare storage 22 into any one or more of the heat exchanger assemblies 36 at the EGR circuit 202, the EGR circuit 204, the heat recovery system 106, other engines 24, or any combination thereof.

The process 650 may then proceed to record changes in the positions of the heat exchangers 18 based on the unique arrangement and the identifier 60 as indicated by block 674. For example, the recordation of changes in the positions of block 674 may be performed at least partially manually and/or automatically using the controller 254 or the portable computing device 126. For example, when the changes are made, a user may manually enter all or part of the change information into the portable computing device 126 using the input/output devices 136. In certain embodiments, the portable computing device 126 may be used to scan or machine read the identifiers 60 disposed on the heat exchangers 18. The user also may manually enter the location information corresponding to the identifiers 60. In certain embodiments, the combustion system 10 may include identifiers at each of the connected positions in the heat exchanger assemblies 36, such as corresponding to each position or stage of the heat exchanger assemblies 36, the location in the EGR circuit 202, the location in the EGR 204, the particular engine 24 or 26, the heat recovery system 106, or any combination thereof. In such embodiments, the portable computing device 126 may be used to scan or machine read the identifiers disposed at the connected positions. Once the changes are entered by the process 650, the process 650 may repeat by returning to block 652 as indicated by arrow 676.

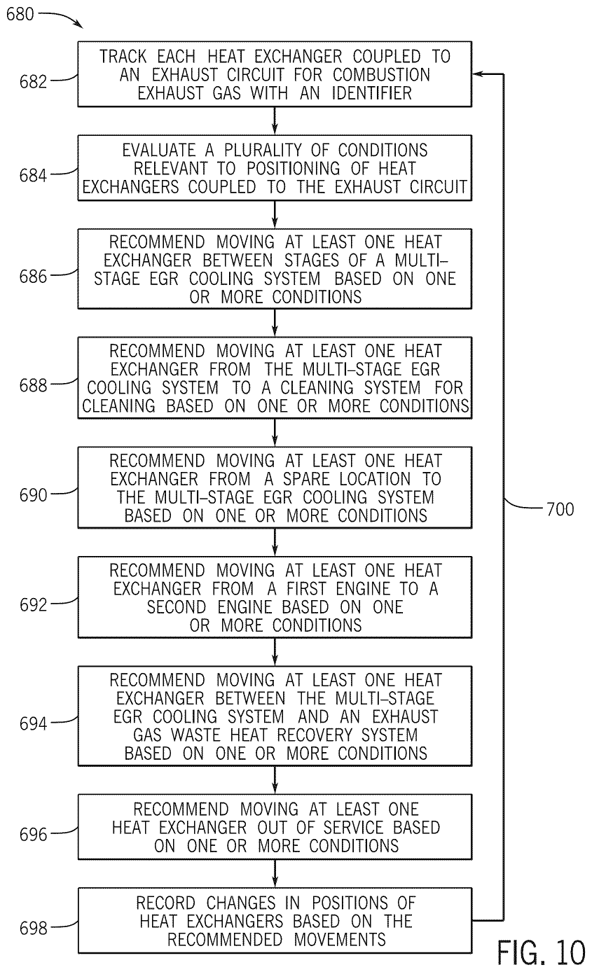

FIG. 10 is a flow chart of an embodiment of a process 680 for shuffling the heat exchangers 18 between various positions in the combustion system 10. As illustrated, the process 680 may include tracking each heat exchanger 18 coupled to an exhaust circuit 28 of a reciprocating engine 26 with an identifier 60 as indicated by block 682. For example, as discussed above, the identifier 60 may include a machine-readable identifier, a human-readable identifier, or a combination thereof, to facilitate tracking of the various locations of the heat exchangers 18. The process 680 may then proceed to evaluate a plurality of conditions relevant to positioning of the heat exchangers 18 coupled to the exhaust circuit as indicated by block 684. The evaluation of block 684 may include automatically evaluating sensor feedback, evaluating alerts and alarms for the combustion system 10, evaluating trends in the overall engine power output or load of the combustion system 10, evaluating time of use and/or particular positions of the heat exchangers 18 in the combustion system 10, or any combination thereof. The evaluation of block 684 may be based on sensor feedback or other time-based parameters. In certain embodiments, the evaluation of block 684 may follow a service schedule or table of operational times and recommended changes in positions of the heat exchangers 18. The evaluation of block 684 also may utilize a computer model or simulation to facilitate the evaluation for potential shuffling of the heat exchangers 18.

Based on the evaluations of block 684, the process 680 may proceed to recommend a variety of changes or movements of the heat exchangers 18. For example, the process 680 may recommend moving at least one heat exchanger 18 between different stages of a multi-stage EGR cooling system based on the one or more conditions as indicated by block 686. The multi-stage EGR cooling system may correspond to the heat exchanger assembly 36 disposed in the EGR circuit 202 or the EGR circuit 204 of the reciprocating engine 26, or one or more EGR circuits in the other engines 24. The multi-stage EGR cooling system may include 2, 3, 4, or more stages as discussed in detail above.

The process 680 also may recommend movements of the heat exchangers 18 to and from off engine positions. For example, the process 680 may recommend moving at least one heat exchanger 18 from the multi-stage EGR cooling system to a cleaning system 20 for cleaning based on the one or more conditions as indicated by block 688. In certain embodiments, if the evaluation indicates a time for cleaning based on a certain amount of lapsed time or performance reduction, then the heat exchanger 18 may be recommended for an offline cleaning by the cleaning system 20. The process 680 also may recommend moving at least one heat exchanger from a spare location to the multi-stage EGR cooling system based on the one or more conditions as indicated by block 690. For example, one of the spare heat exchangers 94, 96, or 98 in the spare storage 22 may be moved into an operational position in one of the heat exchanger assemblies 36 in the EGR circuit 202 or the EGR circuit 204.

The process 680 also may recommend movements of the heat exchangers 18 between different engines, applications, and systems, which are not limited to EGR cooling. For example, the process 680 may recommend moving at least one heat exchanger 18 from a first engine 26 to a second engine 24 based on the one or more conditions as indicated by block 692. The recommended movement between the engines 26 and 24 may be possible due to different performance thresholds in the different engines, different engine sizes, different positions of the EGR circuits, or any combination thereof. For example, the heat exchanger position in the first engine 26 may have a higher performance threshold relative to the heat exchanger position in the second engine 24. The process 680 also may recommend moving at least one heat exchanger 18 between the multi-stage EGR cooling system and an exhaust gas waste heat recovery system 106 based on one or more conditions as indicated by block 694. For example, one of the heat exchangers 18 in the heat exchanger assemblies 36 of the EGR circuits 202 and 204 may be recommended for movement to the heat recovery system 106. The recommended movements may be due to lower performance thresholds or longer potential operating hours acceptable in the heat recovery system 106 relative to the multi-stage EGR cooling systems.

The process 680 also may recommend moving at least one heat exchanger 18 out of service based on one or more conditions as indicated by block 696. For example, the out of service recommendation of block 696 may be due to the heat exchanger 18 exceeding a maximum number of operating hours, a maximum number of moves between connected positions, a maximum number of cleaning cycles with the cleaning system 20, a maximum number of service repairs or other issues, or a performance level that drops below all performance thresholds even after cleaning by the cleaning system 20. The process 680 may then record changes in the positions of the heat exchangers 18 based on the recommended movements as indicated by block 698. The recorded changes may be stored in the memory 262 of the controller 254, the memory 130 of the portable computing device 126, a cloud-based storage, a remote computer system, or any combination thereof. The process 680 may then repeat as indicated by arrow 700.

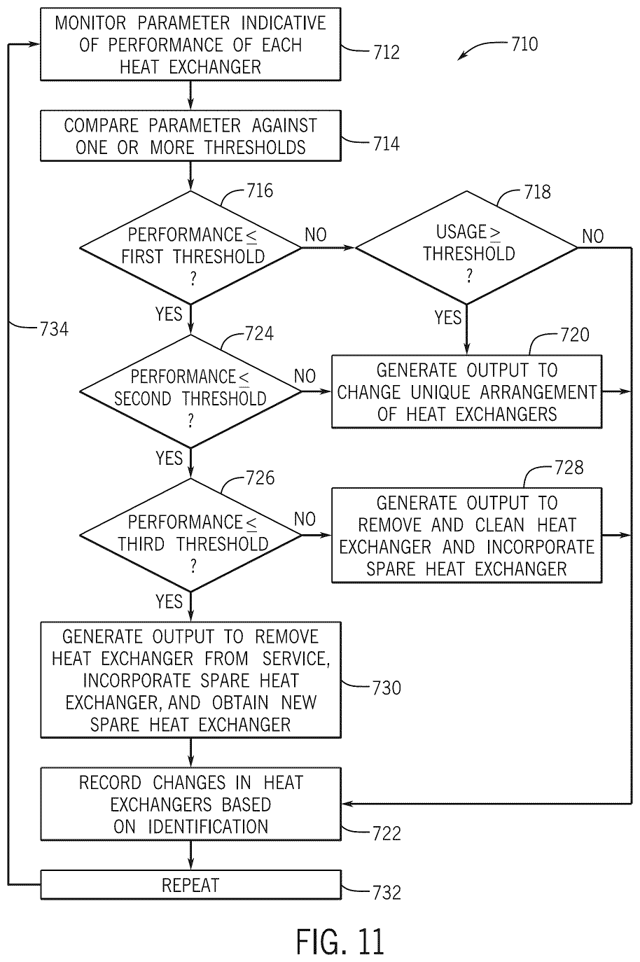

FIG. 11 is a flow chart of an embodiment of a process 710 for shuffling the heat exchangers 18 between various positions in the combustion system 10. As illustrated, the process 710 may include monitoring a parameter indicative of performance of each heat exchanger 18 as indicated by block 712. As discussed above, the monitored parameter may include any of the sensor feedback, monitored parameters, or conditions discussed throughout the present application, including but not limited to, a temperature, a pressure, a flow rate, a leakage, a composition of the fluid, a vibration, a time, reciprocating engine metrics, or any combination thereof. Additionally, one or more of these monitored parameters may be used to calculate or estimate the performance (e.g., effectiveness) of the heat exchanger 18. The process 710 may then proceed to compare the parameter against one or more thresholds as indicated by block 714. For example, the thresholds may be different for each of the connected positions throughout the combustion system 10. In particular, the thresholds may be relatively higher for earlier stages in a multi-stage heat exchange system, such as a multi-stage EGR cooling system, whereas the later stages may have lower thresholds for the particular parameters.

The process 710 then may proceed to evaluate whether the heat exchanger performance is less than or equal to a first threshold as indicated by query block 716. If the performance is greater than the first threshold, then the process 710 may query whether a usage (e.g., operational time) is greater than or equal to a threshold as indicated by query block 718. If the usage is greater than or equal to the threshold at query block 718, then the process 710 may then proceed to generate an output to change the unique arrangement of heat exchangers 18 as indicated by block 720. If the usage is less than the threshold at block 718, then the process 710 may not generate any outputs to make changes and the process may continue to block 722. Likewise, once the block 720 generates an output to change the unique arrangement of heat exchangers, the process 710 proceeds to block 722 to record the changes. The changes in block 720 may include stage changes in one or more heat exchangers, such as an upstream-to-downstream stage change of a first heat exchanger and a downstream-to-upstream stage change of a second heat exchanger. The changes in block 720 may include a recommendation to remove a first heat exchanger from the exhaust circuit, a recommendation to perform a clean-in-place (CIP) procedure on the first heat exchanger, and a recommendation to incorporate a second heat exchanger from a spare storage into the exhaust circuit.

If the process 710 determines that the performance is less than or equal to the first threshold at query block 716, then the process 710 proceeds to a query block 724 to determine whether the performance is less than or equal to a second threshold. If the performance is greater than the second threshold at query block 724, then the process 710 proceeds to generate the output to change the unique arrangement of heat exchangers as indicated by block 720. If the performance is less than or equal to the second threshold at query block 724, then the process 710 proceeds to evaluate whether the performance is less than or equal to a third threshold at query block 726. At query block 726, if the performance is greater than the third threshold, then the process 710 proceeds to generate an output to remove and clean the heat exchanger 18 and incorporate a spare heat exchanger from the spare storage 22 as indicated by block 728. The process 710 then proceeds to record the changes in the heat exchangers based on the identifiers 60 as indicated by block 722.

At query block 726, if the performance is less than or equal to the third threshold, then the process 710 proceeds to generate an output to remove the heat exchanger 18 from service, incorporate a spare heat exchanger from the spare storage 22, and obtain a new spare heat exchanger as indicated by block 730. The process 710 may then proceed to record the changes in heat exchangers 18 based on the identifiers 60 as indicated by block 722. The process 710 may then repeat as indicated by block 732 and arrow 734.

Technical effects of the disclosed embodiments include systems and methods for moving heat exchangers 18 between different positions in a combustion system 10 to increase the useful life and performance of the heat exchangers 18. For example, the movements may be based on performance levels of the heat exchangers 18 compared with performance demands or requirements at each heat exchanger position. The movements may be recommended by a computing device in response to sensor feedback, historical data, user input, computer models, service data, or any combination thereof. The movements also may be based on trends in the sensor feedback, such as trends in parameters indicative of performance (e.g., effectiveness) of the heat exchangers 18. Rather than removing the heat exchangers 18 for cleaning immediately upon a decrease in performance, the heat exchangers 18 may be moved to other locations with lower performance demands, such that the heat exchangers 18 can continue operating for longer periods of time in different positions. The heat exchangers 18 all may be sized the same with common connections (e.g., common mechanical connections and common fluid connections), such that the heat exchangers 18 are readily interchangeable in the different positions. Additionally, the heat exchangers 18 may be designed based on the greatest performance demands of the various heat exchanger positions, such that the heat exchangers 18 may substantially exceed the performance demands of the other heat exchanger positions. As a result, when the heat exchangers 18 no longer perform adequately for the positions with greater performance demands, the heat exchanges 18 still have excess performance levels that are sufficient for the positions with lesser performance demands.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A method, comprising:
detecting, via a controller, a threshold reduction in performance of at least one heat exchanger of a discrete plurality of heat exchangers coupled to an exhaust circuit of a reciprocating engine, wherein the discrete plurality of heat exchangers are configured to be shuffled between a plurality of unique arrangements of positions along the exhaust circuit, wherein the discrete plurality of heat exchangers are disposed in a first unique arrangement of the plurality of unique arrangements of positions along the exhaust circuit, wherein each of the discrete plurality of heat exchangers includes a common mounting interface having common fluid connections enabling each of the discrete plurality of heat exchangers to fluidly couple to the exhaust circuit and one or more fluid supplies when the discrete plurality of heat exchangers are shuffled between the positions along the exhaust circuit, and the common fluid connections comprise common input connections and common output connections; and
generating, via the controller, an output indicative of a second unique arrangement of the plurality of unique arrangements of positions of the discrete plurality of heat exchangers along the exhaust circuit, wherein the plurality of unique arrangements are different from one another, wherein the second unique arrangement of positions of the discrete plurality of heat exchangers has a greater predicted remaining useful life than the first unique arrangement of positions of the discrete plurality of heat exchangers.

2. The method of claim 1, wherein the output includes a recommendation to move the at least one heat exchanger from a first position to a second position having a lower threshold level of performance for the at least one heat exchanger.

3. The method of claim 1, wherein the output indicative of the second unique arrangement is selected based on logic selected from a plurality of logic corresponding to the plurality of unique arrangements of positions of the discrete plurality of heat exchangers.

4. The method of claim 1, wherein the output includes a recommendation of one or more positional changes in the discrete plurality of heat exchangers.

5. The method of claim 4, wherein the one or more positional changes comprise a heat exchanger movement between different stages of a multi-stage heat exchange system having the discrete plurality of heat exchangers.

6. The method of claim 5, wherein the at least one stage change comprises an upstream-to-downstream stage change of a first heat exchanger and a downstream-to-upstream stage change of a second heat exchanger.

7. The method of claim 4, wherein the one or more positional changes comprise a heat exchanger movement between an exhaust gas recirculation (EGR) cooling system and an exhaust gas waste heat recovery system.

8. The method of claim 1, comprising tracking the discrete plurality of heat exchangers disposed in each of the plurality of unique arrangements of positions along the exhaust circuit, wherein tracking comprises reading unique identifiers disposed on the discrete plurality of heat exchangers.

9. The method of claim 8, wherein the unique identifiers comprise human-readable identifiers, machine-readable identifiers, or a combination thereof.

10. The method of claim 8, wherein the unique identifiers comprise at least one of a serial number, a bar code, a radio-frequency identification (RFID) tag, a smart tag, a quick response (QR) code, a numeric identifier, an alphanumeric identifier, a color-coded identifier, a computer-readable chip, a stamped identifier, a marked identifier, an etched or scribed identifier, a tag identifier, or any combination thereof.

11. The method of claim 1, wherein the discrete plurality of heat exchangers comprises exhaust gas recirculation (EGR) coolers of the reciprocating engine.

12. The method of claim 1, wherein the discrete plurality of heat exchangers comprises exhaust gas heat recovery coolers of the reciprocating engine.

13. The method of claim 1, wherein discrete plurality of heat exchangers comprises exhaust gas recirculation (EGR) coolers or exhaust gas heat recovery coolers of a plurality of reciprocating engines, including the reciprocating engine.

14. The method of claim 1, further comprising generating, via the controller, an output indicative of a swap between at least one of the discrete plurality of heat exchangers coupled to the exhaust circuit and at least one additional heat exchanger not coupled to the exhaust circuit, and the at least one additional heat exchanger comprises a new, unused heat exchanger and/or a previously used but cleaned heat exchanger.

15. The method of claim 1, wherein detecting the threshold reduction in performance comprises detecting the threshold reduction in an effectiveness of the at least one heat exchanger.

16. The method of claim 1, wherein detecting the threshold reduction in performance comprises analyzing, for each of the discrete plurality of heat exchangers, feedback from one or more sensors and one or more of: a historical data for one or more parameters measured by sensors, an operational time at each operational location, a service history based on time, a time operated past a prior swap alert override, a cleaning history, or any combination thereof, wherein the one or more sensors comprise a physical sensor, a virtual sensor, or a combination thereof.

17. The method of claim 1, wherein detecting the threshold reduction in performance comprises analyzing cumulative duty metrics, wherein the cumulative duty metrics comprise engine power output without EGR, engine power output with EGR, EGR total operating time, EGR total volume of flow, a total number of stops and starts of the reciprocating engine, or any combination thereof.

18. The method of claim 1, further comprising generating, via the controller, an output indicative of: comprises:
a recommendation to remove a first heat exchanger from the exhaust circuit;
a recommendation to perform a clean-in-place (CIP) procedure on the first heat exchanger; and
a recommendation to incorporate a second heat exchanger from a spare storage into the exhaust circuit.

19. A system, comprising:
a controller of a reciprocating engine, wherein the controller is configured to:
detect a threshold reduction in performance of at least one heat exchanger of a discrete plurality of heat exchangers coupled to an exhaust circuit of the reciprocating engine, wherein the discrete plurality of heat exchangers are configured to be shuffled between a plurality of unique arrangements of positions along the exhaust circuit, wherein the discrete plurality of heat exchangers are disposed in a first unique arrangement of the plurality of unique arrangements of positions along the exhaust circuit, wherein each of the discrete plurality of heat exchangers includes a common mounting interface having common fluid connections enabling each of the discrete plurality of heat exchangers to fluidly couple to the exhaust circuit and one or more fluid supplies when the discrete plurality of heat exchangers are shuffled between the positions along the exhaust circuit, and the common fluid connections comprise common input connections and common output connections; and
generate an output indicative of a second unique arrangement of the plurality of unique arrangements of positions of the discrete plurality of heat exchangers along the exhaust circuit, wherein the plurality of unique arrangements are different from one another, wherein the second unique arrangement of positions of the discrete plurality of heat exchangers has a greater predicted remaining useful life than the first unique arrangement of positions of the discrete plurality of heat exchangers.

20. A system, comprising:
a reciprocating engine;
an exhaust circuit coupled to the reciprocating engine, wherein the exhaust circuit comprises a discrete plurality of heat exchangers coupled with the exhaust circuit in different positions, wherein the discrete plurality of heat exchangers are configured to be shuffled between a plurality of unique arrangements of positions along the exhaust circuit; and
a controller, wherein the controller is configured to:
detect a threshold reduction in performance of at least one heat exchanger of the discrete plurality of heat exchangers coupled to the exhaust circuit of the reciprocating engine, wherein the discrete plurality of heat exchangers are disposed in a first unique arrangement of the plurality of unique arrangements of positions along the exhaust circuit, wherein each of the discrete plurality of heat exchangers includes a common mounting interface having common fluid connections enabling each of the discrete plurality of heat exchangers to fluidly couple to the exhaust circuit and one or more fluid supplies when the discrete plurality of heat exchangers are shuffled between the positions along the exhaust circuit, and the common fluid connections comprise common input connections and common output connections; and
generate an output indicative of a second unique arrangement of the plurality of unique arrangements of positions of the discrete plurality of heat exchangers along the exhaust circuit, wherein the plurality of unique arrangements are different from one another, wherein the second unique arrangement of positions of the discrete plurality of heat exchangers has a greater predicted remaining useful life than the first unique arrangement of positions of the discrete plurality of heat exchangers.
